(19) United States
(12) Patent Application Publication
(10) Pub. No.: US 2026/0238581 A1
(43) Pub. Date: Aug. 13, 2026

(54) CONTROL APPARATUS, SIGNAL TRANSMISSION SYSTEM AND CONTROL METHOD

(71) Applicant: NTT, Inc., Tokyo (JP)

(72) Inventors: Kenji MIYAMOTO, Musashino-shi (JP); Yoshihito SAKAI, Musashino-shi (JP); Tatsuya SHIMADA, Musashino-shi (JP)

(73) Assignee: NTT, Inc., Tokyo (JP)

(21) Appl. No.: 19/153,898

(22) PCT Filed: Feb. 8, 2023
(86) PCT No.: PCT/JP2023/004179

§ 371 Date: Aug. 5, 2025

(51) Int. Cl. H04L 43/087; H04L 27/26; H04L 47/22

(52) U.S. Cl. CPC H04L 43/087; H04L 27/2656; H04L 47/22

(57) ABSTRACT

A control device that is a transfer device controller in a signal transfer system including one or more base stations that accommodate one or more wireless terminals, one or more transfer devices that transfer uplink communication of the one or more wireless terminals received via the one or more base stations to an upper side, and a transfer device controller that controls the one or more transfer devices, the transfer device controller including a control determination unit that acquires wireless control information related to wireless communication between the one or more base stations and the one or more wireless terminals for each of traffic flows from the one or more wireless terminals to an upper device, estimates a delay value occurring in a wireless section for each of packets on the basis of the acquired wireless control information for each of the traffic flows, and performs a delay control instruction for executing adjustment processing of adjusting a packet interval of a plurality of packets by adding a delay to each of the packets using the estimated delay value for each of the packets.

### TECHNICAL FIELD

The present invention relates to a control device, a signal transfer system, and a control method.

### BACKGROUND ART

In signal transmission in a conventional mobile communication system, in a case where a base station and a wireless terminal exchange signal, time division duplex (TDD) in which a downlink signal and an uplink signal are alternately transmitted in a time domain is used, and at that time, transmission and reception of signals are performed in units of wireless transmission data called a transport block.

### CITATION LIST

### Non Patent Literature

Non Patent Literature 1: “3GPP TS 38.300 V16.7.0”, 3GPP (registered trademark), 2022.

Non Patent Literature 2: “3GPP TS 38.214 V16.7.0”, 3GPP (registered trademark), 2022.

### SUMMARY OF INVENTION

### Technical Problem

However, there is a case where jitter occurs due to an uplink transmission waiting time during downlink transmission in TDD or a waiting time for forming a transport block in a case where a size of the transport block is larger than a packet size output by an application layer function in a terminal device.

As a result, end-to-end jitter may increase due to jitter in a wireless transmission section. Note that such a problem is common not only to the mobile communication system but also to wireless communication systems other than the mobile communication system.

In view of the above circumstances, an object of the present invention is to provide a technology capable of reducing an increase in jitter.

### Solution to Problem

One aspect of the present invention is a control device that is a transfer device controller in a signal transfer system including one or more base stations that accommodate one or more wireless terminals, one or more transfer devices that transfer uplink communication of the one or more wireless terminals received via the one or more base stations to an upper side, and a transfer device controller that controls the one or more transfer devices, the transfer device controller including a control determination unit that acquires wireless control information related to wireless communication between the one or more base stations and the one or more wireless terminals for each of traffic flows from the one or more wireless terminals to an upper device, estimates a delay value occurring in a wireless section for each of packets on the basis of the acquired wireless control information for each of the traffic flows, and performs a delay control instruction for executing adjustment processing of adjusting a packet interval of a plurality of packets by adding a delay to each of the packets using the estimated delay value for each of the packets.

One aspect of the present invention is a signal transfer system including one or more base stations that accommodate one or more wireless terminals, one or more transfer devices that transfer uplink communication of the one or more wireless terminals received via the one or more base stations to an upper side, a transfer device controller that controls the one or more transfer devices, an information acquisition unit that acquires wireless control information related to wireless communication between the one or more base stations and the one or more wireless terminals for each of traffic flows from the one or more wireless terminals to an upper device, a control determination unit that estimates a delay value occurring in a wireless section for each of packets on the basis of the wireless control information acquired for each of the traffic flows, and performs a delay control instruction for executing adjustment processing of adjusting a packet interval of a plurality of packets by adding a delay to each of the packets using the estimated delay value for each of the packets, and a delay control unit that executes the adjustment processing in accordance with the delay control instruction of the control determination unit.

One aspect of the present invention is a control method performed by a transfer device controller in a signal transfer system including one or more base stations that accommodate one or more wireless terminals, one or more transfer devices that transfer uplink communication of the one or more wireless terminals received via the one or more base stations to an upper side, and a transfer device controller that controls the one or more transfer devices, the control method including acquiring wireless control information related to wireless communication between the one or more base stations and the one or more wireless terminals for each of traffic flows from the one or more wireless terminals to an upper device, estimating a delay value occurring in a wireless section for each of packets on the basis of the acquired wireless control information for each of the traffic flows, and performing a delay control instruction for executing adjustment processing of adjusting a packet interval of a plurality of packets by adding a delay to each of the packets using the estimated delay value for each of the packets.

### Advantageous Effects of Invention

According to the present invention, it is possible to reduce an increase in jitter.

### BRIEF DESCRIPTION OF DRAWINGS

FIG. 1 A diagram illustrating a system configuration example of a signal transfer system in a first embodiment.

FIG. 2 A diagram for describing an outline of adjustment processing in the first embodiment.

FIG. 3 A diagram for describing an outline of the adjustment processing in the first embodiment.

FIG. 4 A flowchart illustrating an example of a flow of processing executed by the signal transfer system in the first embodiment.

FIG. 5 A diagram illustrating a system configuration example of a signal transfer system in a modification of the first embodiment.

FIG. 6 A diagram illustrating a system configuration example of a signal transfer system in a first configuration of a second embodiment.

FIG. 7 A flowchart illustrating an example of a flow of processing executed by the signal transfer system in the first configuration of the second embodiment.

FIG. 8 A diagram illustrating a system configuration example of a signal transfer system in a second configuration of the second embodiment.

FIG. 9 A flowchart illustrating an example of a flow of processing executed by the signal transfer system in the second configuration of the second embodiment.

FIG. 10 A diagram illustrating a system configuration example of a signal transfer system in a third configuration of the second embodiment.

FIG. 11 A flowchart illustrating an example of a flow of processing executed by the signal transfer system in the third configuration of the second embodiment.

FIG. 12 A diagram illustrating a system configuration example of a signal transfer system in a first configuration of a third embodiment.

FIG. 13 A flowchart illustrating an example of a flow of processing executed by the signal transfer system in the first configuration of the third embodiment.

FIG. 14 A diagram illustrating a system configuration example of a signal transfer system in a second configuration of the third embodiment.

FIG. 15 A flowchart illustrating an example of a flow of processing executed by the signal transfer system in the second configuration of the third embodiment.

FIG. 16 A diagram illustrating a system configuration example of a signal transfer system in a third configuration of the third embodiment.

FIG. 17 A flowchart illustrating an example of a flow of processing executed by the signal transfer system in the third configuration of the third embodiment.

FIG. 18 A diagram illustrating a system configuration example of a signal transfer system in a fourth configuration of the third embodiment.

FIG. 19 A flowchart illustrating an example of a flow of processing executed by the signal transfer system in the fourth configuration of the third embodiment.

FIG. 20 A diagram illustrating a system configuration example of a signal transfer system in a first configuration of a fourth embodiment.

FIG. 21 A flowchart illustrating an example of a flow of processing executed by the signal transfer system in the first configuration of the fourth embodiment.

FIG. 22 A diagram illustrating a system configuration example of a signal transfer system in a second configuration of the fourth embodiment.

FIG. 23 A flowchart illustrating an example of a flow of processing executed by the signal transfer system in the second configuration of the fourth embodiment.

FIG. 24 A diagram illustrating a system configuration example of a signal transfer system in a third configuration of the fourth embodiment.

FIG. 25 A flowchart illustrating an example of a flow of processing executed by the signal transfer system in the third configuration of the fourth embodiment.

FIG. 26 A diagram illustrating a system configuration example of a signal transfer system in a fourth configuration of the fourth embodiment.

FIG. 27 A flowchart illustrating an example of a flow of processing executed by the signal transfer system in the fourth configuration of the fourth embodiment.

### DESCRIPTION OF EMBODIMENTS

Hereinafter, an embodiment of the present invention will be described with reference to the drawings.

### First Embodiment

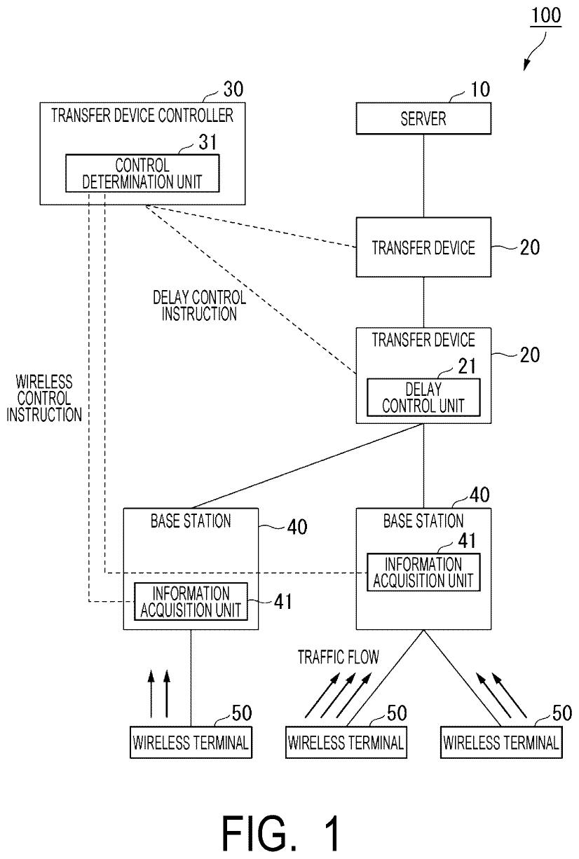

FIG. 1 is a diagram illustrating a system configuration example of a signal transfer system 100 in a first embodiment. The signal transfer system 100 is a system that transfers a signal from one communication device to the other communication device. The signal transfer system 100 includes, for example, a server 10, one or more transfer devices 20, a transfer device controller 30, and one or more base stations 40.

The server 10 is a device that communicates with each of one or more wireless terminals 50 connected to each base station 40. For example, the server 10 receives an uplink signal transmitted from the wireless terminal 50.

The transfer device 20 is a device that transfers a signal exchanged between an upper device (for example, the server 10) and each of one or more wireless terminals 50. For example, the transfer device 20 transfers the uplink signal transmitted from the wireless terminal 50 to the upper device. Furthermore, the transfer device 20 has a function of executing adjustment processing in response to an instruction from the transfer device controller 30.

The adjustment processing is a process of adjusting a packet interval of a plurality of packets by adding a delay to each packet using a delay value for each packet included in an instruction transmitted from the transfer device controller 30. In the adjustment processing, the packet interval of the plurality of packets is adjusted within a range in which the delay value for each packet and an original delay requirement are satisfied. Note that, in a case where there is a plurality of traffic flows, in the adjustment processing, the packet interval of the plurality of packets is adjusted within a range in which the delay value for each packet and the original delay requirement are satisfied and on the basis of the priority of each traffic flow. Thus, it is possible to perform control so that jitter is minimized in the wireless terminal 50.

Here, the above-described packet means a packet propagated in an uplink direction and transmitted to a transmission destination such as an upper device. Therefore, when the transmission destination is the server 10, the packet is a packet transmitted from the wireless terminal 50 to the server 10.

The transfer device controller 30 is a device that controls the one or more transfer devices 20 by transmitting control signals. Furthermore, the transfer device controller 30 has a function of acquiring information (hereinafter referred to as “wireless control information”) related to wireless communication between the base station 40 and the wireless terminal 50, and estimating a delay value occurring in the wireless section for each packet on the basis of the acquired wireless control information.

The wireless control information includes band information for each traffic flow, information indicating priority for each traffic flow, and wireless setting information. The band information for each traffic flow is, for example, a scheduling request, an uplink grant, a buffer status report, a PDCP SDU data volume for each 5G QoS Indicator (5QI), a PDCP PDU size, and the like. The information indicating priority for each traffic flow is a QoS Class Indicator, a 5G QoS Indicator, or the like. The wireless setting information is a time division duplex (TDD) pattern, a wireless frequency, a wireless bandwidth, and the like. The time division duplex (TDD) pattern is information indicating a packet transmission/reception timing.

The base station 40 is a device that communicates with each of one or more wireless terminals 50. For example, the base station 40 transmits a signal transferred from the transfer device 20 to the wireless terminal 50, and transfers a signal received from the wireless terminal 50 to the transfer device 20. Furthermore, the base station 40 has a function of acquiring wireless control information for each traffic flow. The base station 40 transfers the acquired wireless control information for each traffic flow to the transfer device controller 30.

The wireless terminal 50 has one or more traffic flows.

The one or more transfer devices 20, the transfer device controller 30, and the one or more base stations 40 included in the signal transfer system 100 are configured using, for example, a processor such as a central processing unit (CPU), a memory, and a communication interface. Each device of the one or more transfer devices 20, the transfer device controller 30, and the one or more base stations 40 functions as a communication device including a control unit when the processor executes a program.

The control unit provides each function for causing the communication device to function as a transfer device 20, the transfer device controller 30, or a base station 40. All or some of the functions of the control unit may be implemented by using hardware such as an application specific integrated circuit (ASIC), a programmable logic device (PLD), or a field programmable gate array (FPGA).

The program may be recorded on a computer-readable recording medium. The computer-readable recording medium is, for example, a portable medium such as a flexible disk, a magneto-optical disc, a ROM, a CD-ROM, or a semiconductor storage device (for example, solid state drive (SSD)), or a storage device such as a hard disk or a semiconductor storage device built in a computer system. The above program may be transmitted via a telecommunication line.

Next, a specific configuration of each device will be described. Each base station 40 includes an information acquisition unit 41. The information acquisition unit 41 included in the base station 40 acquires the wireless control information for each traffic flow from the wireless terminal 50 toward the server 10. The information acquisition unit 41 included in the base station 40 notifies the transfer device controller 30 of the acquired wireless control information.

Note that each of the base stations 40 may be, for example, a Wi-Fi (registered trademark) access point. The signal transfer system 100 is not necessarily applied to a mobile communication system, and may be applied to a wireless communication system other than the mobile communication system.

The transfer device controller 30 includes a control determination unit 31. The control determination unit 31 acquires the wireless control information acquired by the information acquisition unit 41 of each base station 40. The control determination unit 31 estimates a delay value occurring in the wireless section for each packet in a plurality of traffic flows on the basis of the acquired wireless control information. The control determination unit 31 transmits a delay control instruction for executing the adjustment processing using the estimated delay value for each packet to the transfer device 20. The delay control instruction includes information of the delay value for each packet estimated by the control determination unit 31, information indicating priority, and the like.

Here, a method of estimating the delay value will be described. First, as a premise, in the wireless section, there is a delay that is added periodically. Accordingly, the control determination unit 31 uses the band information to estimate the delay value at the normal time of each packet, and uses the wireless setting information to estimate the delay value added periodically and its cycle. The control determination unit 31 determines whether each packet is a normal delay or a delay obtained by adding a periodically added delay by combining the band information and the wireless setting information, and estimates a delay value of each packet.

The control determination unit 31 may use machine learning when estimating the delay value occurring in the wireless section for each packet. For example, the control determination unit 31 may predict the delay value occurring in the wireless section for each packet on the basis of the past wireless control information using machine learning. Then, the control determination unit 31 may transmit the delay control instruction to the transfer device 20 using the predicted delay value.

Each transfer device 20 includes a delay control unit 21. The delay control unit 21 executes adjustment processing in accordance with the delay control instruction transmitted from the transfer device controller 30. Specifically, the delay control unit 21 adds a delay to each of the packets of the plurality of traffic flows by using each delay value included in the delay control instruction. Here, the delay control unit 21 adds a delay to each of the packets of the plurality of traffic flows so that jitter of the delay in the base station 40 is alleviated on the upper side of the base station 40 in consideration of the priority for each traffic flow within a range satisfying a predetermined delay requirement.

In the signal transfer system 100 in the first embodiment, the delay control unit 21 is included in the control unit of the transfer device 20, the control determination unit 31 is included in the control unit of the transfer device controller 30, and the information acquisition unit 41 is included in the control unit of the base station 40.

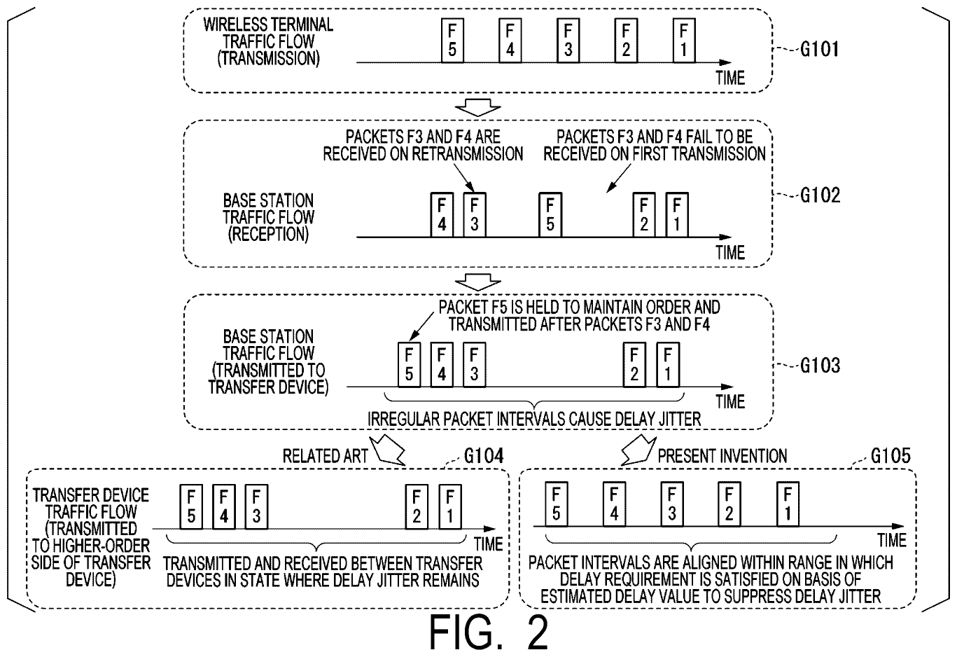

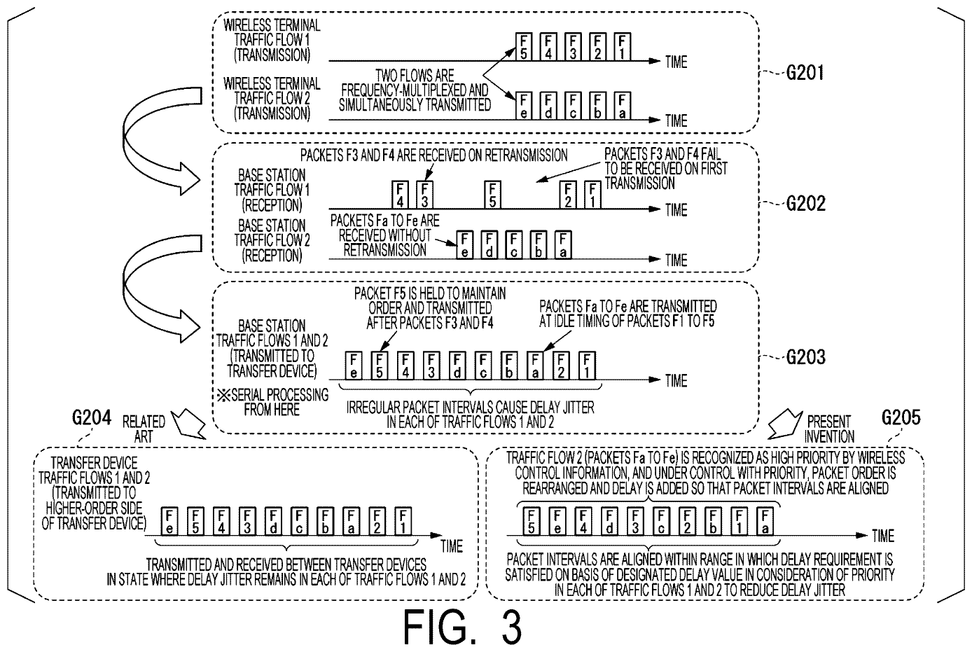

Next, an outline of the above-described adjustment processing will be described. FIGS. 2 and 3 are diagrams for describing an outline of the adjustment processing in the first embodiment. An outline of the adjustment processing will be described using a single traffic flow as an example in FIG. 2, and an outline of the adjustment processing will be described using a plurality of traffic flows as an example in FIG. 3. First, description will be made with reference to FIG. 2.

An image G101 of FIG. 2 illustrates an example in which the wireless terminal 50 transmits five packets F1 to F5 to the base station 40 at equal intervals in the traffic flow. An image G102 of FIG. 2 illustrates a situation in which the base station 40 has received the packets F1 to F5 transmitted from the wireless terminal 50. More specifically, the image G102 of FIG. 2 illustrates a situation in which the base station 40 normally receives the packets F1, F2, and F5 and fails in the first reception of the packets F3 and F4 but normally receives the retransmitted packets F3 and F4.

An image G103 of FIG. 2 illustrates a situation in which the base station 40 has transmitted the received packets F1 to F5 to the transfer device 20. More specifically, the image G103 of FIG. 2 illustrates a situation in which the transfer device controller 30 immediately transmits the packets F1 and F2 among the normally received packets F1, F2, and F5 to the transfer device 20, and transmits the packet F5 after the packets F3 and F4 in order to maintain the order of packets. Note that, in FIG. 2, description of a packet reception status in the transfer device 20 is omitted.

An image G104 of FIG. 2 illustrates a situation in which the transfer device 20 transfers the packets F1 to F5 received from the base station 40 to the upper device. As illustrated in the image G104 of FIG. 2, in a case where the adjustment processing is not performed, the packets F1 to F5 transferred from the transfer device 20 to the upper device are transferred in a state where the delay jitter remains. Therefore, the transmission interval between the packet F2 and the packet F3 is larger than the transmission interval between other packets, and delay jitter occurs. As a result, the jitter is increased.

On the other hand, in the adjustment processing in the first embodiment, one or more transfer devices 20 add a delay to each packet within a range satisfying the delay requirement using the delay value for each packet notified by the transfer device controller 30, thereby performing adjustment so that the packet intervals become uniform. As a result, as illustrated in an image G105, the packet intervals of the plurality of packets become uniform. Therefore, in the example of the image G105, jitter is reduced. As described above, by executing the adjustment processing, an increase in jitter is reduced.

Next, the adjustment processing in a case where there is a plurality of traffic flows will be described with reference to FIG. 3. An image G201 of FIG. 3 illustrates an example in which the wireless terminal 50 simultaneously transmits five packets of packets F1 to F5 and five packets of packets Fa to Fe to the base station 40 by frequency multiplexing in a plurality of traffic flows. First, the wireless terminal 50 transmits the packets F1 to F5 to the base station 40 at equal intervals in the first traffic flow (hereinafter referred to as “traffic flow 1”). The wireless terminal 50 transmits the packets Fa to Fe to the base station 40 at equal intervals in the second traffic flow (hereinafter referred to as “traffic flow 2”). The packets F1 to F5 and the packets Fa to Fe are frequency-multiplexed and simultaneously transmitted.

An image G202 of FIG. 3 illustrates a situation in which the base station 40 has received the packets F1 to F5 and the packets Fa to Fe transmitted from the wireless terminal 50. More specifically, the image G202 of FIG. 3 illustrates a situation in which the base station 40 normally receives the packets F1, F2, and F5 and fails in the first reception of the packets F3 and F4, but normally receives the retransmitted packets F3 and F4 and normally receives the packets Fa to Fe without making a retransmission request.

An image G203 of FIG. 3 illustrates a situation in which the base station 40 has transmitted the received packets F1 to F5 and packets Fa to Fe to the transfer device 20. The base station 40 immediately transmits the packets F1 and F2 among the normally received packets F1, F2, and F5 to the transfer device 20. On the other hand, the base station 40 needs to hold the packet F5 until the packets F3 and F4 are normally received by retransmission, in order to maintain the order of packets.

Next, the base station 40 transmits the packets Fa to Fe at an idle timing. The image G203 of FIG. 3 illustrates a situation in which the base station 40 transmits the packets Fa to Fd to the transfer device 20 at equal intervals at an idle timing until the packet F3 is normally received by retransmission after transmitting the packet F2. When the packets F3 and F4 are normally received by retransmission, the base station 40 transmits the packets F3 to F5 to the transfer device 20 at equal intervals. The base station 40 transmits the packets Fe to the transfer device 20 after transmitting the packets F3 to F5. Note that, in FIG. 3, description of a packet reception status in the transfer device 20 is omitted.

An image G204 of FIG. 3 illustrates a situation in which the transfer device 20 transfers the packets F1 to F5 and the packets Fa to Fe received from the base station 40 to the upper device. As illustrated in the image G204 of FIG. 3, in a case where the adjustment processing is not performed, the packets F1 to F5 and the packets Fa to Fe transferred from the transfer device 20 to the upper device are transferred in a state where the delay jitter remains. Specifically, the transmission interval between the packet F2 and the packet F3 is larger than the transmission interval between other packets, and delay jitter occurs. Furthermore, in the above flow, the transmission interval between the packet Fd and the packet Fe becomes larger than the transmission interval between other packets, and delay jitter occurs.

That is, in the above flow, the packet intervals become irregular in each of the traffic flows 1 and 2, and delay jitter occurs. Note that, as described above, up to this point, the packets F1 to F5 and the packets Fa to Fe are transmitted and received in a similar flow in the related art. Thereafter, in the related art, while the delay jitter that has occurred in the base station is maintained, the packets F1 to F5 and the packets Fa to Fe are transferred to the upper side by one or more transfer devices 20.

On the other hand, in the adjustment processing in the first embodiment, one or more transfer devices 20 use the delay value for each packet notified by the transfer device controller 30 to perform adjustment so that the packet intervals are uniform by adding a delay to each packet in consideration of the priority of each traffic flow within a range satisfying a predetermined delay requirement. As a result, as illustrated in an image G205, the packet intervals of the plurality of packets become uniform. Therefore, in the example of the image G205, jitter is reduced. As described above, by executing the adjustment processing, an increase in jitter is reduced.

With such a configuration, the signal transfer system 100 of the present embodiment can alleviate the delay jitter that has occurred in the base station 40 on the upper side with respect to the base station 40. Note that FIG. 3 illustrates a case where the one or more transfer devices 20 recognize the traffic flow 2 (packets Fa to Fe) as higher priority on the basis of information of priority notified by the transfer device controller 30, and the one or more transfer devices 20 rearrange the order of packets on the basis of the priority and perform adjustment so that the packet intervals are aligned.

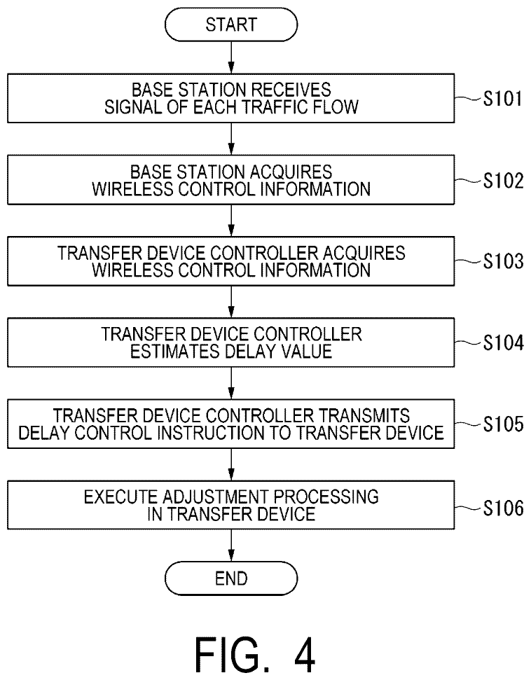

FIG. 4 is a flowchart illustrating an example of a flow of processing executed by the signal transfer system 100 in the first embodiment. In the signal transfer system 100, the processing illustrated in FIG. 4 is repeatedly performed.

The base station 40 receives a signal of each traffic flow (step S101). The information acquisition unit 41 included in the base station 40 acquires the wireless control information for each traffic flow on the basis of the received signal (step S102). The information acquisition unit 41 transmits the acquired wireless control information to the transfer device controller 30. Furthermore, the base station 40 transfers the received signal to the transfer device 20 to which the own device is connected.

The control determination unit 31 included in the transfer device controller 30 acquires the wireless control information transmitted from each information acquisition unit 41 (step S103). The control determination unit 31 estimates the delay value for each packet using the acquired wireless control information (step S104). Thereafter, the control determination unit 31 generates a delay control instruction including information of the estimated delay value for each packet. The control determination unit 31 transmits the generated delay control instruction to the transfer device 20 (step S105).

The delay control unit 21 included in the transfer device 20 acquires the delay control instruction transmitted from the transfer device controller 30. The delay control unit 21 executes the adjustment processing on a plurality of packets on the basis of the acquired delay control instruction (step S106). Thus, the packet intervals of the plurality of packets are uniformly adjusted, and the jitter is reduced. Thereafter, the plurality of packets after the adjustment processing is transferred to the server 10. Note that the processing in step S106 may be performed by all the transfer devices 20 or may be performed by some of the transfer devices 20. In a case where the adjustment processing is performed in all the transfer devices 20, the control determination unit 31 transmits the delay control instruction to all the transfer devices 20.

With the signal transfer system 100 configured as described above, the control determination unit 31 included in the transfer device controller 30 estimates the delay value occurring in the wireless section for each packet on the basis of the wireless control information for each traffic flow acquired by the base station 40. Then, the control determination unit 31 gives a delay control instruction for executing the adjustment processing using the estimated delay value for each packet to the transfer device 20. Thus, the delay control unit 21 of the transfer device 20 executes the adjustment processing of adjusting the packet interval of the plurality of packets by using the delay value for each packet included in the delay control instruction. This makes it possible to reduce jitter occurring in the uplink.

### Modification of First Embodiment

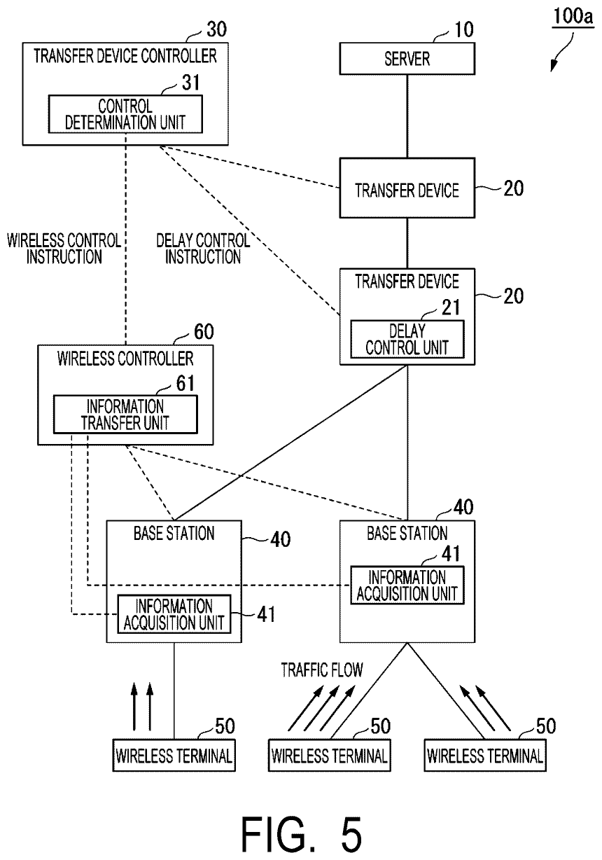

The signal transfer system 100 may include a wireless controller 60, and the transfer device controller 30 may acquire the wireless control information from the wireless controller 60. FIG. 5 is a diagram illustrating a system configuration example of a signal transfer system 100a in a modification of the first embodiment. The signal transfer system 100a includes, for example, a server 10, one or more transfer devices 20, a transfer device controller 30, one or more base stations 40, and the wireless controller 60. The signal transfer system 100a is different from the signal transfer system 100 in that the wireless controller 60 is newly provided. Hereinafter, differences from the signal transfer system 100 will be mainly described.

The information acquisition unit 41 of the base station 40 transmits the acquired wireless control information to the wireless controller 60.

The wireless controller 60 controls operation of the base station 40. Further, the wireless controller 60 includes an information transfer unit 61. The information transfer unit 61 included in the wireless controller 60 acquires the wireless control information transmitted from the information acquisition unit 41. The information transfer unit 61 transfers the acquired wireless control information to the transfer device controller 30.

In this manner, the transfer device controller 30 may acquire the wireless control information not directly from the information acquisition unit 41 included in the base station 40 but via the information transfer unit 61 included in the wireless controller 60. Processing after the transfer device controller 30 acquires the wireless control information is similar to that in the first embodiment.

### Second Embodiment

In a second embodiment, a signal transfer system using distributed central stations and distributed stations as base stations will be described. In the second embodiment, three configuration examples will be described.

### [First Configuration of Second Embodiment]

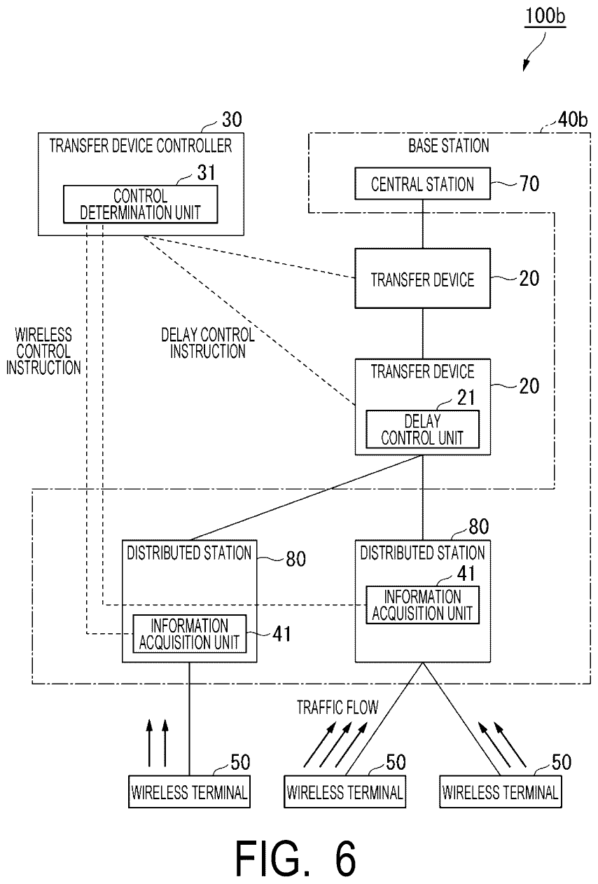

FIG. 6 is a diagram illustrating a system configuration example of a signal transfer system 100b in a first configuration of the second embodiment. The signal transfer system 100b includes, for example, one or more transfer devices 20, a transfer device controller 30, and a base station 40b. The base station 40b includes a central station 70 and one or more distributed stations 80. As described above, the signal transfer system 100b is different from the signal transfer system 100 in that it does not include the server 10 but includes the base station 40b including the central station 70 and one or more distributed stations 80 instead of the base station 40. Hereinafter, differences from the signal transfer system 100 will be mainly described.

The central station 70 and one or more distributed stations 80 are configured using, for example, a processor such as a CPU, a memory, and a communication interface. Each device of the central station 70 and the one or more distributed stations 80 functions as a communication device including a control unit when the processor executes a program.

The control unit provides each function for causing the communication device to function as the central station 70 or the distributed station 80. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disc, a ROM, a CD-ROM, or a semiconductor storage device (for example, SSD), or a storage device such as a hard disk or a semiconductor storage device built in a computer system. The above program may be transmitted via a telecommunication line.

For example, the central station 70 and one or more distributed stations 80 in the first configuration of the second embodiment are a central unit (CU) and one or more distributed units (DU) in the mobile communication system. In this case, a section between the CU and the DUs where transfer devices 20 are installed is referred to as a mobile midhaul (MMH). For example, the central station 70 and the one or more distributed stations 80 in the first configuration of the second embodiment may be a DU and one or more radio units (RUs) in the mobile communication system. In this case, a section between the DU and the RUs where transfer devices 20 are installed is referred to as a mobile front haul (MFH).

Note that the central station 70 may be a Wi-Fi controller, and one or more distributed stations 80 may be Wi-Fi access points. The signal transfer system 100b is not necessarily applied to the mobile communication system, and may be applied to a wireless communication system other than the mobile communication system.

The central station 70 is a central station that transmits and receives signals. The central station 70 is an aspect of the upper device.

The distributed station 80 is a device that communicates with the wireless terminal 50. The distributed station 80 transmits a signal transferred from the transfer device 20 to the wireless terminal 50 or transfers a signal received from the wireless terminal 50 to the transfer device 20 of the transfer destination by communication with the wireless terminal 50.

The distributed station 80 includes an information acquisition unit 41. The information acquisition unit 41 included in the distributed station 80 acquires the wireless control information for each traffic flow from the wireless terminal 50 toward the server 10. The information acquisition unit 41 included in the distributed station 80 notifies the transfer device controller 30 of the acquired wireless control information.

In the signal transfer system 100b in the first configuration of the second embodiment, the delay control unit 21 is included in the control unit of the transfer device 20, the control determination unit 31 is included in the control unit of the transfer device controller 30, and the information acquisition unit 41 is included in the control unit of the distributed station 80.

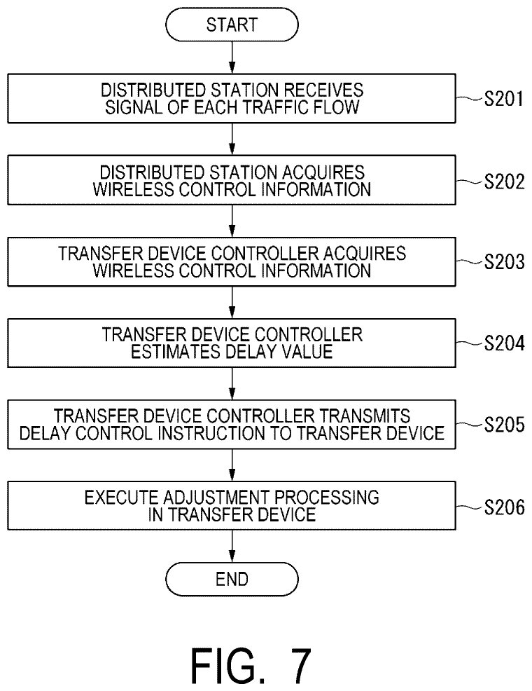

FIG. 7 is a flowchart illustrating an example of a flow of processing executed by the signal transfer system 100b in the first configuration of the second embodiment. In the signal transfer system 100b, the processing illustrated in FIG. 6 is repeatedly performed.

The distributed station 80 receives a signal of each traffic flow (step S201). The information acquisition unit 41 included in the distributed station 80 acquires the wireless control information for each traffic flow on the basis of the received signal (step S202). The information acquisition unit 41 transmits the acquired wireless control information to the transfer device controller 30. Furthermore, the distributed station 80 transfers the received signal to the transfer device 20 to which the own device is connected.

The control determination unit 31 included in the transfer device controller 30 acquires the wireless control information transmitted from each information acquisition unit 41 (step S203). The control determination unit 31 estimates the delay value for each packet using the acquired wireless control information (step S204). Thereafter, the control determination unit 31 generates a delay control instruction including information of the estimated delay value for each packet. The control determination unit 31 transmits the generated delay control instruction to the transfer device 20 (step S205).

The delay control unit 21 included in the transfer device 20 acquires the delay control instruction transmitted from the transfer device controller 30. The delay control unit 21 executes the adjustment processing on a plurality of packets on the basis of the acquired delay control instruction (step S206). Thus, the packet intervals of the plurality of packets are uniformly adjusted, and the jitter is reduced. Thereafter, the plurality of packets after the adjustment processing is transferred to the server 10. Note that the processing in step S106 may be performed by all the transfer devices 20 or may be performed by some of the transfer devices 20. In a case where the adjustment processing is performed in all the transfer devices 20, the control determination unit 31 transmits the delay control instruction to all the transfer devices 20.

With the signal transfer system 100b configured as described above, the control determination unit 31 included in the transfer device controller 30 estimates the delay value occurring in the wireless section for each packet on the basis of the wireless control information for each traffic flow acquired by the distributed station 80. Then, the control determination unit 31 gives a delay control instruction for executing the adjustment processing using the estimated delay value for each packet to the transfer device 20. Thus, the delay control unit 21 of the transfer device 20 executes the adjustment processing of adjusting the packet interval of the plurality of packets by using the delay value for each packet included in the delay control instruction. This makes it possible to reduce jitter occurring in the uplink.

### [Second Configuration of Second Embodiment]

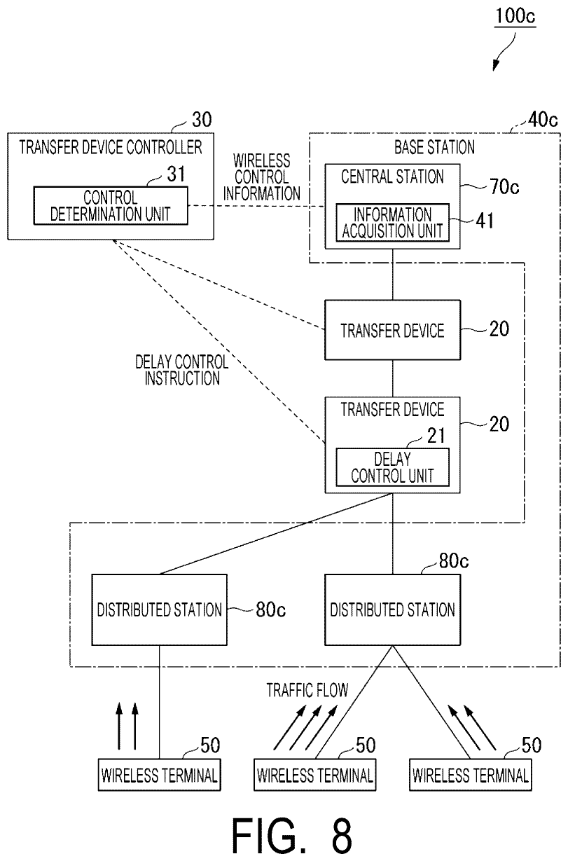

FIG. 8 is a diagram illustrating a system configuration example of a signal transfer system 100c in a second configuration of the second embodiment. The signal transfer system 100c includes, for example, one or more transfer devices 20, the transfer device controller 30, and a base station 40c. The base station 40c includes a central station 70c and one or more distributed stations 80c. As described above, the signal transfer system 100c is different from the signal transfer system 100b in that the base station 40c is provided instead of the base station 40b. Hereinafter, differences from the signal transfer system 100b will be mainly described.

The central station 70c and one or more distributed stations 80c are configured using, for example, a processor such as a CPU, a memory, and a communication interface. Each device of the central station 70c and the one or more distributed stations 80c functions as a communication device including a control unit when the processor executes a program.

The control unit provides each function for causing the communication device to function as the central station 70c or the distributed station 80c. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disc, a ROM, a CD-ROM, or a semiconductor storage device (for example, SSD), or a storage device such as a hard disk or a semiconductor storage device built in a computer system. The above program may be transmitted via a telecommunication line.

For example, the central station 70c and one or more distributed stations 80c in the second configuration of the second embodiment are a CU and one or more DUs in the mobile communication system. In this case, a section between the CU and the DUs where transfer devices 20 are installed is referred to as MMH. For example, the central station 70c and one or more distributed stations 80c in the second configuration of the second embodiment may be a DU and one or more RUs in the mobile communication system. In this case, a section between the DU and the RUs where transfer devices 20 are installed is referred to as MFH.

Note that the central station 70c may be a Wi-Fi controller, and one or more distributed stations 80c may be Wi-Fi access points. The signal transfer system 100c is not necessarily applied to the mobile communication system, and may be applied to a wireless communication system other than the mobile communication system.

The central station 70c is a central station that transmits and receives signals. Furthermore, the central station 70c includes the information acquisition unit 41. The information acquisition unit 41 included in the central station 70c acquires the wireless control information for each traffic flow from the wireless terminal 50 toward the server 10. The information acquisition unit 41 included in the central station 70c notifies the transfer device controller 30 of the acquired wireless control information. The central station 70c is an aspect of the upper device.

The distributed station 80c is different from the distributed station 80 in not including the information acquisition unit 41. Therefore, the distributed station 80c does not acquire the wireless control information. The distributed station 80c is a device that communicates with the wireless terminal 50. The distributed station 80c transmits a signal transferred from the transfer device 20 to the wireless terminal 50 or transfers a signal received from the wireless terminal 50 to the transfer device 20 of the transfer destination by communication with the wireless terminal 50.

In the signal transfer system 100c in the second configuration of the second embodiment, the delay control unit 21 is included in the control unit of the transfer device 20, the control determination unit 31 is included in the control unit of the transfer device controller 30, and the information acquisition unit 41 is included in the control unit of the central station 70c.

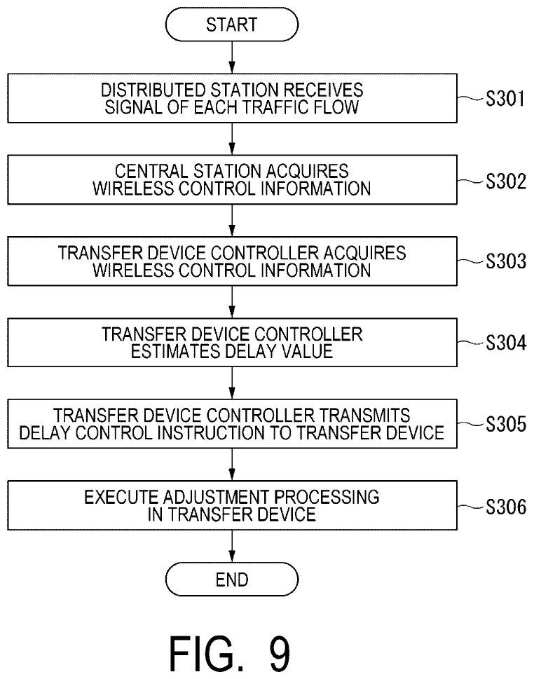

FIG. 9 is a flowchart illustrating an example of a flow of processing executed by the signal transfer system 100c in the second configuration of the second embodiment. In the signal transfer system 100c, the processing illustrated in FIG. 9 is repeatedly performed.

The distributed station 80c receives a signal of each traffic flow (step S301). The distributed station 80c transmits the received signal of each traffic flow to the transfer device 20. The transfer device 20 transfers the signal of each traffic flow transmitted from the distributed station 80c to the central station 70c. The central station 70c receives the signal of each traffic flow transferred from the transfer device 20. The information acquisition unit 41 included in the central station 70c acquires the wireless control information for each traffic flow on the basis of the received signal (step S302). The information acquisition unit 41 transmits the acquired wireless control information to the transfer device controller 30.

The control determination unit 31 included in the transfer device controller 30 acquires the wireless control information transmitted from the information acquisition unit 41 (step S303). The control determination unit 31 estimates the delay value for each packet using the acquired wireless control information (step S304). As illustrated in FIG. 8, in a case where the central station 70c includes the information acquisition unit 41, the control determination unit 31 included in the transfer device controller 30 performs delay control of the packet input to the transfer device 20 at the next timing on the basis of the band information included in the wireless control information acquired from the information acquisition unit 41. For example, the control determination unit 31 estimates the delay value for each packet input to the transfer device 20 at the next timing on the basis of information indicating future information included in the band information. As an example, when the signal of each traffic flow is input to the transfer device 20 at the timing of time t, the control determination unit 31 estimates the delay value for each packet included in the signal of each traffic flow input to the transfer device 20 at the timing of time t+1. As described above, in the signal transfer system 100c, the control determination unit 31 estimates the delay value for performing the adjustment processing of each packet input to the transfer device 20 in the future. Here, the information indicating the future information means, for example, a traffic amount occurring after a reference time point with a certain time point as a reference. Thereafter, the control determination unit 31 generates a delay control instruction including information of the estimated delay value for each packet. The control determination unit 31 transmits the generated delay control instruction to the transfer device 20 (step S305).

The delay control unit 21 included in the transfer device 20 acquires the delay control instruction transmitted from the transfer device controller 30. On the basis of the acquired delay control instruction, the delay control unit 21 executes the adjustment processing on a plurality of packets included in the signal of each traffic flow received by the distributed station 80c at a timing later than the signal received by the distributed station 80c in the processing of step S301 (step S306). Thus, the packet intervals of the plurality of packets are uniformly adjusted, and the jitter is reduced. Thereafter, the plurality of packets after the adjustment processing is transferred to the server 10. Note that the processing in step S306 may be performed by all the transfer devices 20 or may be performed by some of the transfer devices 20. In a case where the adjustment processing is performed in all the transfer devices 20, the control determination unit 31 transmits the delay control instruction to all the transfer devices 20.

With the signal transfer system 100c configured as described above, the control determination unit 31 included in the transfer device controller 30 estimates the delay value occurring in the wireless section for each packet on the basis of the wireless control information for each traffic flow acquired by the central station 70c. In particular, the signal transfer system 100c estimates the delay value for performing the adjustment processing of each packet input to the transfer device 20 in the future. Then, the control determination unit 31 gives a delay control instruction for executing the adjustment processing using the estimated delay value for each packet to the transfer device 20. Thus, the delay control unit 21 of the transfer device 20 executes the adjustment processing of adjusting the packet interval of a plurality of packets to be input in the future by using the delay value for each packet included in the delay control instruction. This makes it possible to reduce jitter occurring in the uplink.

### [Third Configuration of Second Embodiment]

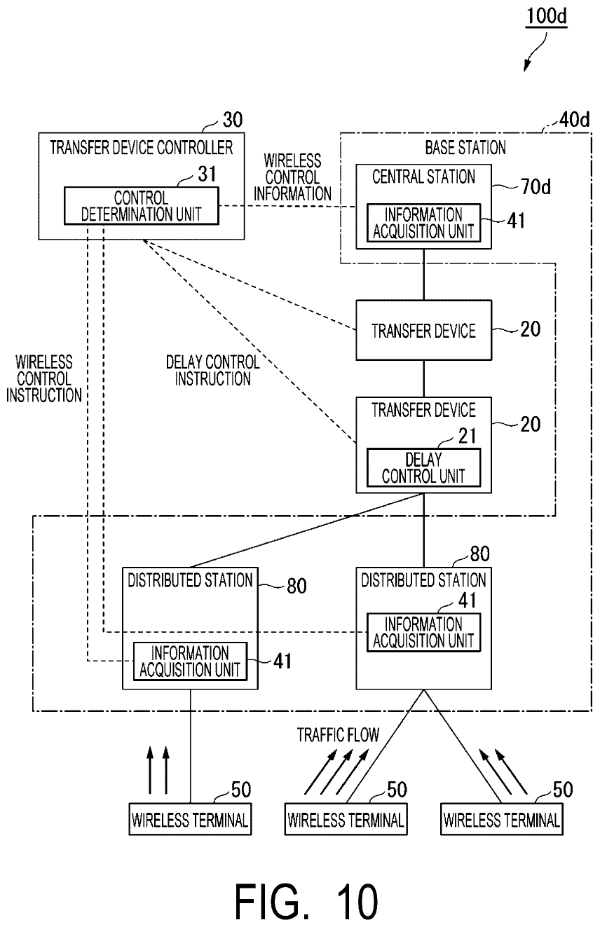

FIG. 10 is a diagram illustrating a system configuration example of a signal transfer system 100d in a third configuration of the second embodiment. The signal transfer system 100d includes, for example, one or more transfer devices 20, the transfer device controller 30, and a base station 40d. The base station 40d includes a central station 70d and one or more distributed stations 80. As described above, the signal transfer system 100d is different from the signal transfer system 100b in that the base station 40d is provided instead of the base station 40b. Hereinafter, differences from the signal transfer system 100b will be mainly described.

The central station 70d includes, for example, a processor such as a CPU, a memory, and a communication interface. The device of the central station 70d functions as a communication device including a control unit when the processor executes a program.

The control unit provides each function for causing the communication device to function as the central station 70d. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disc, a ROM, a CD-ROM, or a semiconductor storage device (for example, SSD), or a storage device such as a hard disk or a semiconductor storage device built in a computer system. The above program may be transmitted via a telecommunication line.

For example, the central station 70d and one or more distributed stations 80 in the third configuration of the second embodiment are a CU and one or more DUs in the mobile communication system. In this case, a section between the CU and the DUs where transfer devices 20 are installed is referred to as MMH. For example, the central station 70d and the one or more distributed stations 80 in the third configuration of the second embodiment may be a DU and one or more RUs in the mobile communication system. In this case, a section between the DU and the RUs where transfer devices 20 are installed is referred to as MFH.

Note that the central station 70d may be a Wi-Fi controller, and one or more distributed stations 80 may be Wi-Fi access points. The signal transfer system 100d is not necessarily applied to the mobile communication system, and may be applied to a wireless communication system other than the mobile communication system.

The central station 70d is a central station that transmits and receives signals. Furthermore, the central station 70d includes the information acquisition unit 41. The information acquisition unit 41 included in the central station 70d acquires the wireless control information for each traffic flow from the wireless terminal 50 toward the server 10. The information acquisition unit 41 included in the central station 70d notifies the transfer device controller 30 of the acquired wireless control information. The central station 70d is an aspect of the upper device.

The distributed station 80 is a device that communicates with the wireless terminal 50. The distributed station 80 transmits a signal transferred from the transfer device 20 to the wireless terminal 50 or transfers a signal received from the wireless terminal 50 to the transfer device 20 of the transfer destination by communication with the wireless terminal 50. The distributed station 80 includes the information acquisition unit 41. The information acquisition unit 41 included in the distributed station 80 acquires the wireless control information for each traffic flow from the wireless terminal 50 toward the server 10. The information acquisition unit 41 included in the base station 40 notifies the transfer device controller 30 of the acquired wireless control information.

In the signal transfer system 100d in the third configuration of the second embodiment, the delay control unit 21 is included in the control unit of the transfer device 20, the control determination unit 31 is included in the control unit of the transfer device controller 30, and the information acquisition unit 41 is included in each of the control unit of the central station 70d and the control unit of the distributed station 80.

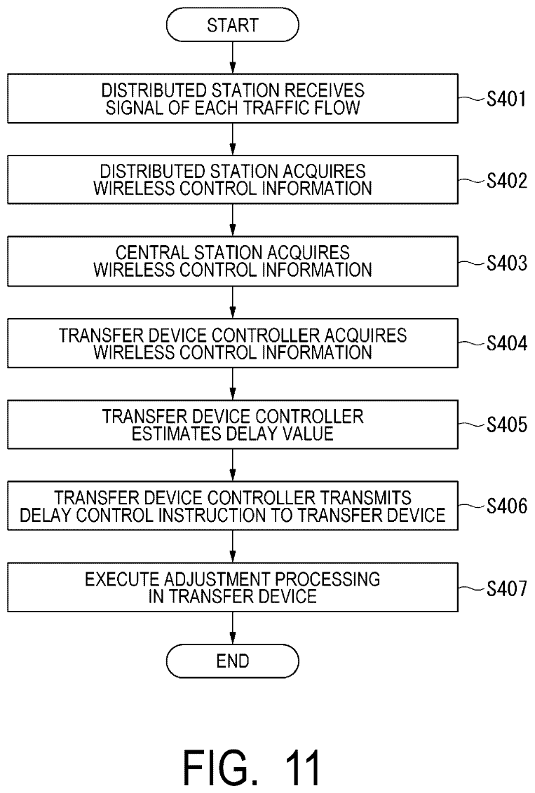

FIG. 11 is a flowchart illustrating an example of a flow of processing executed by the signal transfer system 100d in the third configuration of the second embodiment. In the signal transfer system 100d, the processing illustrated in FIG. 11 is repeatedly performed.

The distributed station 80 receives a signal of each traffic flow (step S401). The information acquisition unit 41 included in the distributed station 80 acquires the wireless control information for each traffic flow on the basis of the received signal (step S402). The information acquisition unit 41 transmits the acquired wireless control information to the transfer device controller 30. Furthermore, the distributed station 80 transfers the received signal to the transfer device 20 to which the own device is connected.

The transfer device 20 transfers the signal of each traffic flow transmitted from the distributed station 80 to the central station 70d. The central station 70d receives the signal of each traffic flow transferred from the transfer device 20. The information acquisition unit 41 included in the central station 70d acquires the wireless control information for each traffic flow on the basis of the received signal (step S403). The information acquisition unit 41 transmits the acquired wireless control information to the transfer device controller 30.

The control determination unit 31 included in the transfer device controller 30 acquires the wireless control information transmitted from each information acquisition unit 41 (step S404). The control determination unit 31 estimates the delay value for each packet using a plurality of pieces of the acquired wireless control information (step S405). Specifically, the control determination unit 31 included in the transfer device controller 30 estimates a delay value of each packet used for executing the adjustment processing on each packet included in the signal of each traffic flow received by the distributed station 80 in the processing of step S401 on the basis of the wireless control information acquired by the information acquisition unit 41 of the distributed station 80.

As illustrated in FIG. 10, in a case where the information acquisition unit 41 is included in the central station 70d, the control determination unit 31 included in the transfer device controller 30 performs delay control of the packet input to the transfer device 20 at the next timing on the basis of the band information included in the wireless control information acquired from the information acquisition unit 41 included in the central station 70d. For example, the control determination unit 31 estimates the delay value for each packet input to the transfer device 20 at the next timing on the basis of information indicating future information included in the band information. As described above, in the signal transfer system 100d, the control determination unit 31 estimates the delay value for performing the adjustment processing of each packet input to the transfer device 20 at the present and future timings on the basis of the wireless control information acquired by the information acquisition unit 41 of the distributed station 80 and the wireless control information acquired by the information acquisition unit 41 of the central station 70d. Thereafter, the control determination unit 31 generates a delay control instruction including information of the estimated delay value for each packet. The control determination unit 31 transmits the generated delay control instruction to the transfer device 20 (step S406).

The delay control unit 21 included in the transfer device 20 acquires the delay control instruction transmitted from the transfer device controller 30. The delay control unit 21 executes the adjustment processing on a plurality of packets on the basis of the acquired delay control instruction (step S407). For example, the delay control unit 21 executes the adjustment processing on a plurality of packets included in the signal received by the distributed station 80 in the processing of step S401 by using information of the delay value for each packet estimated on the basis of the wireless control information acquired by the information acquisition unit 41 of the distributed station 80. Furthermore, the delay control unit 21 executes the adjustment processing on a plurality of packets included in the signal of each traffic flow received by the distributed station 80 at a timing later than the signal received by the distributed station 80 in the processing of step S401 by using information of the delay value for each packet estimated on the basis of the wireless control information acquired by the information acquisition unit 41 of the central station 70d. Thus, the packet intervals of the plurality of packets are uniformly adjusted, and the jitter is reduced. Thereafter, the plurality of packets after the adjustment processing is transferred to the server 10. Note that the processing in step S106 may be performed by all the transfer devices 20 or may be performed by some of the transfer devices 20. In a case where the adjustment processing is performed in all the transfer devices 20, the control determination unit 31 transmits the delay control instruction to all the transfer devices 20.

With the signal transfer system 100d configured as described above, the control determination unit 31 included in the transfer device controller 30 estimates the delay value occurring in the wireless section for each packet on the basis of the wireless control information for each traffic flow acquired by the central station 70d and the wireless control information for each traffic flow acquired by the distributed station 80. In particular, the signal transfer system 100d estimates the delay value for performing the adjustment processing of each packet input at present and in the future to the transfer device 20. Then, the control determination unit 31 gives a delay control instruction for executing the adjustment processing using the estimated delay value for each packet to the transfer device 20. Thus, the delay control unit 21 of the transfer device 20 executes the adjustment processing of adjusting the packet interval of a plurality of packets to be input at present and in the future by using the delay value for each packet included in the delay control instruction. This makes it possible to reduce jitter occurring in the uplink.

### Modification Example of Second Embodiment

The signal transfer systems 100b, 100c, and 100d may include the wireless controller 60 as in the modification of the first embodiment, and the transfer device controller 30 may be configured to acquire the wireless control information from the wireless controller 60. In such a configuration, the wireless controller 60 includes an information transfer unit 61. The information transfer unit 61 of the wireless controller 60 acquires the wireless control information transmitted from the information acquisition unit 41. The information transfer unit 61 transfers the acquired wireless control information to the transfer device controller 30.

### Third Embodiment

In a third embodiment, a signal transfer system that performs all of acquisition of the wireless control information, transmission of a delay control instruction, and adjustment processing in a base station will be described. In the third embodiment, four configuration examples will be described.

### [First Configuration of Third Embodiment]

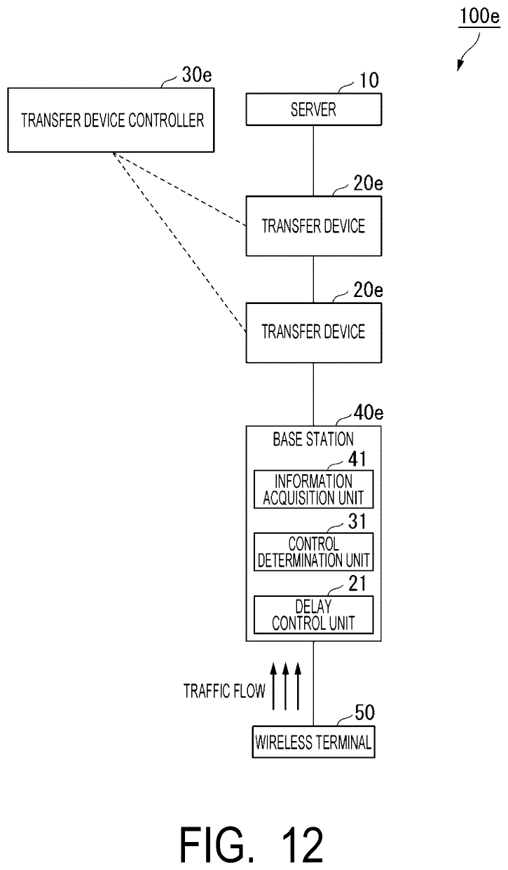

FIG. 12 is a diagram illustrating a system configuration example of a signal transfer system 100e in a first configuration of the third embodiment. The signal transfer system 100e includes, for example, one or more transfer devices 20e, a transfer device controller 30e, and a base station 40e. As described above, the signal transfer system 100e is different from the signal transfer system 100 in including the transfer device 20e, the transfer device controller 30e, and the base station 40e instead of the transfer device 20, the transfer device controller 30, and the base station 40. Hereinafter, differences from the signal transfer system 100 will be mainly described.

The base station 40e is configured using, for example, a processor such as a CPU, a memory, and a communication interface. The device of the base station 40e functions as a communication device including a control unit when the processor executes a program.

The control unit provides each function for causing the communication device to function as the base station 40e. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disc, a ROM, a CD-ROM, or a semiconductor storage device (for example, SSD), or a storage device such as a hard disk or a semiconductor storage device built in a computer system. The above program may be transmitted via a telecommunication line.

The transfer device 20e is different from the transfer device 20 in that the delay control unit 21 is not provided. That is, the transfer device 20e does not perform the adjustment processing. The transfer device 20e is a device that transfers a signal exchanged between the upper device (for example, the server 10) and each of one or more wireless terminals 50. For example, the transfer device 20e transfers an uplink signal transmitted from the wireless terminal 50 to the upper device.

The transfer device controller 30e is different from the transfer device controller 30 in not including the control determination unit 31. That is, the transfer device controller 30e does not estimate the delay value for each packet and does not transmit the delay control instruction. The transfer device controller 30e is a device that controls one or more transfer devices 20e by transmitting a control signal.

The base station 40e includes a delay control unit 21, a control determination unit 31, and an information acquisition unit 41. The information acquisition unit 41 included in the base station 40e acquires the wireless control information for each traffic flow from the wireless terminal 50 toward the server 10. The information acquisition unit 41 included in the base station 40e notifies the control determination unit 31 of the acquired wireless control information. The control determination unit 31 included in the base station 40e acquires the wireless control information acquired by the information acquisition unit 41. The control determination unit 31 estimates a delay value occurring in the wireless section for each packet in a plurality of traffic flows on the basis of the acquired wireless control information. The control determination unit 31 outputs a delay control instruction for executing the adjustment processing using the estimated delay value for each packet to the delay control unit 21. The delay control unit 21 included in the base station 40e executes the adjustment processing in accordance with the delay control instruction output from the control determination unit 31.

In the signal transfer system 100e in the first configuration of the third embodiment, the delay control unit 21, the control determination unit 31, and the information acquisition unit 41 are included in the control unit of the base station 40e.

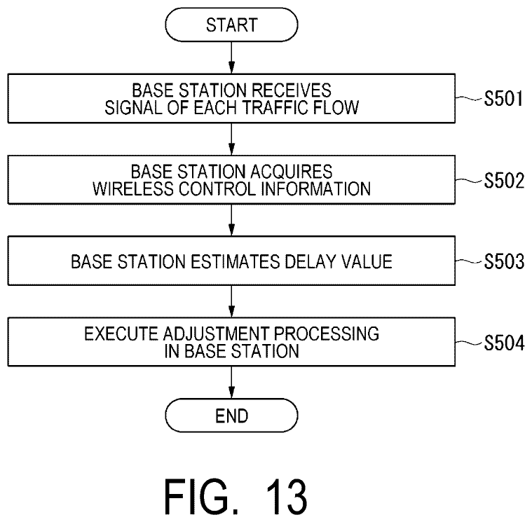

FIG. 13 is a flowchart illustrating an example of a flow of processing executed by the signal transfer system 100e in the first configuration of the third embodiment. In the signal transfer system 100e, the processing illustrated in FIG. 13 is repeatedly performed.

The base station 40e receives a signal of each traffic flow (step S501). The information acquisition unit 41 included in the base station 40e acquires the wireless control information for each traffic flow on the basis of the received signal (step S502). The information acquisition unit 41 outputs the acquired wireless control information to the control determination unit 31.

The control determination unit 31 included in the base station 40e acquires the wireless control information output from the information acquisition unit 41. The control determination unit 31 estimates the delay value for each packet using the acquired wireless control information (step S503). Thereafter, the control determination unit 31 generates a delay control instruction including information of the estimated delay value for each packet. The control determination unit 31 outputs the generated delay control instruction to the delay control unit 21.

The delay control unit 21 included in the base station 40e acquires the delay control instruction output from the control determination unit 31. The delay control unit 21 executes the adjustment processing on a plurality of packets on the basis of the acquired delay control instruction (step S504). Thus, the packet intervals of the plurality of packets are uniformly adjusted, and the jitter is reduced. Thereafter, the plurality of packets after the adjustment processing is transferred to the server 10 via the transfer device 20e.

With the signal transfer system 100e configured as described above, the control determination unit 31 included in the base station 40e estimates the delay value occurring in the wireless section for each packet on the basis of the acquired wireless control information for each traffic flow. Then, the delay control unit 21 included in the base station 40e executes the adjustment processing of adjusting the packet interval of the plurality of packets using the delay value for each packet included in the delay control instruction. This makes it possible to reduce jitter occurring in the uplink.

Furthermore, in the signal transfer system 100e, the base station 40e performs from acquisition of the wireless control information to the adjustment processing. Thus, the transfer device 20e need not include the function of performing the adjustment processing. Therefore, a transfer device having a normal transfer function can be used as the transfer device 20e.

### [Second Configuration of Third Embodiment]

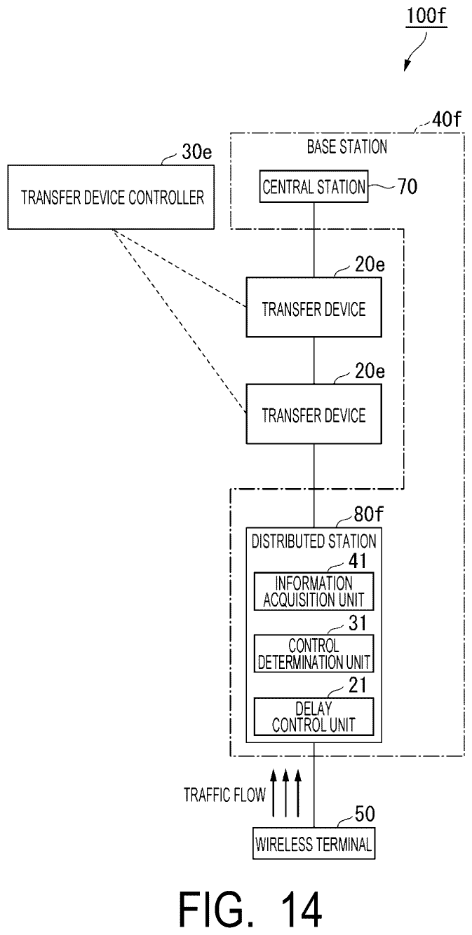

FIG. 14 is a diagram illustrating a system configuration example of a signal transfer system 100f in a second configuration of the third embodiment. The signal transfer system 100f includes, for example, one or more transfer devices 20e, the transfer device controller 30e, and a base station 40f. As described above, the signal transfer system 100f is different from the signal transfer system 100e in that it does not include the server 10 but includes the base station 40f including a central station 70 and one or more distributed stations 80f instead of the base station 40e. Hereinafter, differences from the signal transfer system 100e will be mainly described.

The distributed station 80f is configured using, for example, a processor such as a CPU, a memory, and a communication interface. The device of the distributed station 80f functions as a communication device including a control unit when the processor executes a program.

The control unit provides each function for causing the communication device to function as the distributed station 80f. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disc, a ROM, a CD-ROM, or a semiconductor storage device (for example, SSD), or a storage device such as a hard disk or a semiconductor storage device built in a computer system. The above program may be transmitted via a telecommunication line.

For example, the central station 70 and one or more distributed stations 80f in the second configuration of the third embodiment are a CU and one or more DUs in the mobile communication system. In this case, a section between the CU and the DUs where transfer devices 20e are installed is referred to as MMH. For example, the central station 70 and one or more distributed stations 80f in the second configuration of the third embodiment may be a DU and one or more RUs in the mobile communication system. In this case, a section between the DU and the RUs where transfer devices 20e are installed is referred to as MFH.

Note that the central station 70 may be a Wi-Fi controller, and one or more distributed stations 80f may be Wi-Fi access points. The signal transfer system 100f is not necessarily applied to the mobile communication system, and may be applied to a wireless communication system other than the mobile communication system.

The central station 70 is a central station that transmits and receives signals. The central station 70 is an aspect of the upper device.

The distributed station 80f is a device that communicates with the wireless terminal 50. The distributed station 80f transmits a signal transferred from the transfer device 20e to the wireless terminal 50 or transfers a signal received from the wireless terminal 50 to the transfer device 20e of the transfer destination by communication with the wireless terminal 50.

The distributed station 80f includes the delay control unit 21, the control determination unit 31, and the information acquisition unit 41. The information acquisition unit 41 included in the distributed station 80f acquires the wireless control information for each traffic flow from the wireless terminal 50 toward the server 10. The information acquisition unit 41 included in the distributed station 80f notifies the control determination unit 31 of the acquired wireless control information. The control determination unit 31 included in the distributed station 80f acquires the wireless control information acquired by the information acquisition unit 41. The control determination unit 31 estimates a delay value occurring in the wireless section for each packet in a plurality of traffic flows on the basis of the acquired wireless control information. The control determination unit 31 outputs a delay control instruction for executing the adjustment processing using the estimated delay value for each packet to the delay control unit 21. The delay control unit 21 included in the base station 40e executes the adjustment processing in accordance with the delay control instruction output from the control determination unit 31.

In the signal transfer system 100f in the second configuration of the third embodiment, the delay control unit 21, the control determination unit 31, and the information acquisition unit 41 are included in the control unit of the distributed station 80f.

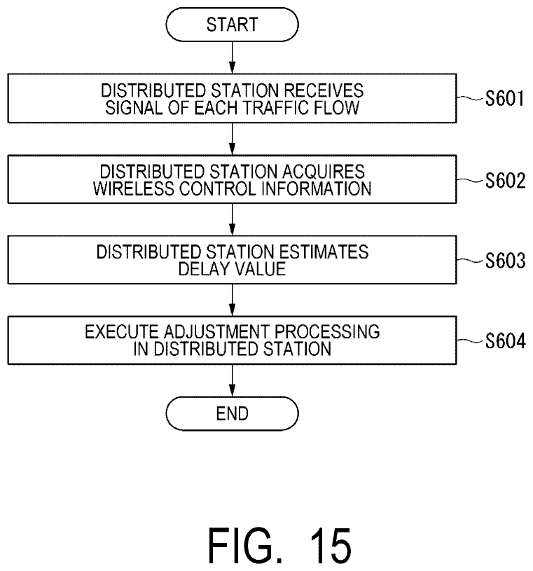

FIG. 15 is a flowchart illustrating an example of a flow of processing executed by the signal transfer system 100f in the second configuration of the third embodiment. In the signal transfer system 100f, the processing illustrated in FIG. 15 is repeatedly performed.

The distributed station 80f receives a signal of each traffic flow (step S601). The information acquisition unit 41 included in the distributed station 80f acquires the wireless control information for each traffic flow on the basis of the received signal (step S602). The information acquisition unit 41 outputs the acquired wireless control information to the control determination unit 31.

The control determination unit 31 included in the distributed station 80f acquires the wireless control information output from the information acquisition unit 41. The control determination unit 31 estimates the delay value for each packet using the acquired wireless control information (step S603). Thereafter, the control determination unit 31 generates a delay control instruction including information of the estimated delay value for each packet. The control determination unit 31 outputs the generated delay control instruction to the delay control unit 21.

The delay control unit 21 included in the distributed station 80f acquires the delay control instruction output from the control determination unit 31. The delay control unit 21 executes the adjustment processing on a plurality of packets on the basis of the acquired delay control instruction (step S604). Thus, the packet intervals of the plurality of packets are uniformly adjusted, and the jitter is reduced. Thereafter, the plurality of packets after the adjustment processing is transferred to the server 10 via the transfer device 20e.

With the signal transfer system 100f configured as described above, the control determination unit 31 included in the distributed station 80f estimates the delay value occurring in the wireless section for each packet on the basis of the acquired wireless control information for each traffic flow. Then, the delay control unit 21 included in the distributed station 80f executes the adjustment processing of adjusting the packet interval of the plurality of packets using the delay value for each packet included in the delay control instruction. This makes it possible to reduce jitter occurring in the uplink.

Furthermore, in the signal transfer system 100f, the base station 40e performs from acquisition of the wireless control information to the adjustment processing. Thus, the transfer device 20e need not include the function of performing the adjustment processing. Therefore, a transfer device having a normal transfer function can be used as the transfer device 20e.

### [Third Configuration of Third Embodiment]

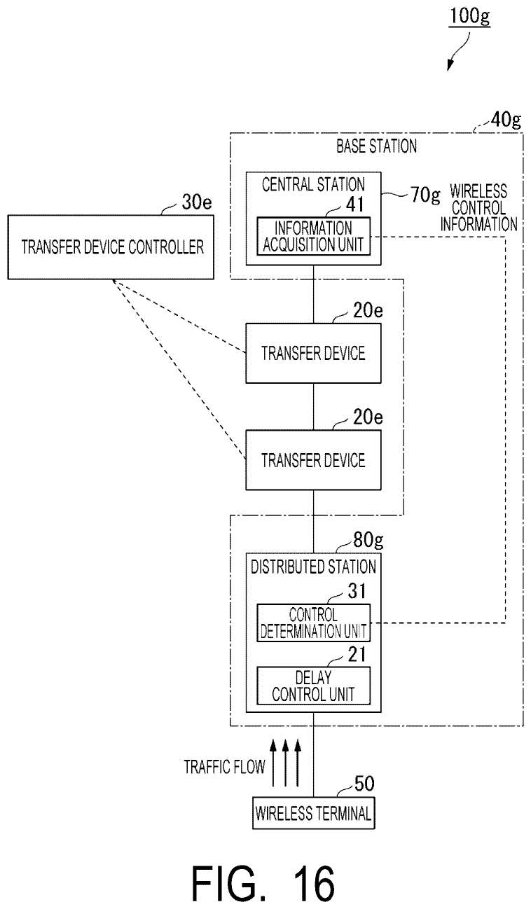

FIG. 16 is a diagram illustrating a system configuration example of a signal transfer system 100g in a third configuration of the third embodiment. The signal transfer system 100g includes, for example, one or more transfer devices 20e, the transfer device controller 30e, and a base station 40g. As described above, the signal transfer system 100g is different from the signal transfer system 100e in that it does not include the server 10 but includes the base station 40g including a central station 70g and one or more distributed stations 80g instead of the base station 40e. Hereinafter, differences from the signal transfer system 100e will be mainly described.

The central station 70g and the distributed station 80g are configured using, for example, a processor such as a CPU, a memory, and a communication interface. Each device of the central station 70g and the distributed station 80g functions as a communication device including a control unit when the processor executes a program.

The control unit provides each function for causing the communication device to function as the central station 70g or the distributed station 80g. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disc, a ROM, a CD-ROM, or a semiconductor storage device (for example, SSD), or a storage device such as a hard disk or a semiconductor storage device built in a computer system. The above program may be transmitted via a telecommunication line.

For example, the central station 70g and one or more distributed stations 80g in the third configuration of the third embodiment are a CU and one or more DUs in the mobile communication system. In this case, a section between the CU and the DUs where transfer devices 20e are installed is referred to as MMH. For example, the central station 70g and one or more distributed stations 80g in the third configuration of the third embodiment may be a DU and one or more RUs in the mobile communication system. In this case, a section between the DU and the RUs where transfer devices 20e are installed is referred to as MFH.

Note that the central station 70g may be a Wi-Fi controller, and one or more distributed stations 80g may be Wi-Fi access points. The signal transfer system 100g is not necessarily applied to the mobile communication system, and may be applied to a wireless communication system other than the mobile communication system.

The central station 70g is a central station that transmits and receives signals. Furthermore, the central station 70g includes the information acquisition unit 41. The information acquisition unit 41 included in the central station 70g acquires the wireless control information for each traffic flow from the wireless terminal 50 toward the server 10. The information acquisition unit 41 included in the central station 70g notifies the distributed station 80g of the acquired wireless control information. The central station 70g is an aspect of the upper device.

The distributed station 80g is a device that communicates with the wireless terminal 50. The distributed station 80g transmits a signal transferred from the transfer device 20e to the wireless terminal 50 or transfers a signal received from the wireless terminal 50 to the transfer device 20e of the transfer destination by communication with the wireless terminal 50.

The distributed station 80g includes the delay control unit 21 and the control determination unit 31. The control determination unit 31 included in the distributed station 80g acquires the wireless control information acquired by the information acquisition unit 41 included in the central station 70g. The control determination unit 31 estimates a delay value occurring in the wireless section for each packet in a plurality of traffic flows on the basis of the acquired wireless control information. The control determination unit 31 outputs a delay control instruction for executing the adjustment processing using the estimated delay value for each packet to the delay control unit 21. The delay control unit 21 included in the distributed station 80g executes the adjustment processing in accordance with the delay control instruction output from the control determination unit 31.

In the signal transfer system 100g in the third configuration of the third embodiment, the information acquisition unit 41 is included in the control unit of the central station 70g, and the delay control unit 21 and the control determination unit 31 are included in the control unit of the distributed station 80g.

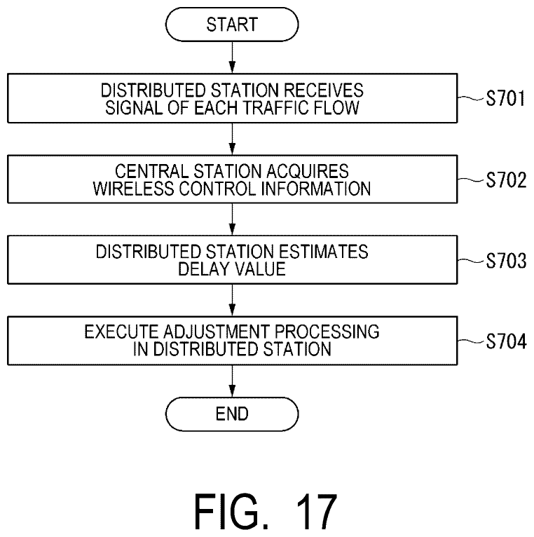

FIG. 17 is a flowchart illustrating an example of a flow of processing executed by the signal transfer system 100g in the third configuration of the third embodiment. In the signal transfer system 100g, the processing illustrated in FIG. 17 is repeatedly performed.

The distributed station 80g receives a signal of each traffic flow (step S701). The distributed station 80g transmits the received signal of each traffic flow to the transfer device 20e. The transfer device 20e transfers the signal of each traffic flow transmitted from the distributed station 80g to the central station 70g. The central station 70g receives the signal of each traffic flow transferred from the transfer device 20e.

The information acquisition unit 41 included in the central station 70g acquires the wireless control information for each traffic flow on the basis of the received signal (step S702). The information acquisition unit 41 transmits the acquired wireless control information to the control determination unit 31 included in the distributed station 80g. For example, the information acquisition unit 41 transmits the wireless control information to the control determination unit 31 included in the distributed station 80g via the transfer device 20e.

The control determination unit 31 included in the distributed station 80g acquires the wireless control information transmitted from the information acquisition unit 41 included in the central station 70g. The control determination unit 31 estimates the delay value for each packet using the acquired wireless control information (step S703). As illustrated in FIG. 16, in a case where the information acquisition unit 41 is included in the central station 70g, the control determination unit 31 included in the distributed station 80g performs delay control of the packet input to the distributed station 80g at the next timing on the basis of the band information included in the wireless control information acquired from the information acquisition unit 41. For example, the control determination unit 31 estimates the delay value for each packet input to the distributed station 80g at the next timing on the basis of information indicating future information included in the band information. As described above, in the signal transfer system 100g, the control determination unit 31 estimates the delay value for performing the adjustment processing of each packet input to the distributed station 80g in the future. Thereafter, the control determination unit 31 generates a delay control instruction including information of the estimated delay value for each packet. The control determination unit 31 outputs the generated delay control instruction to the delay control unit 21.

The delay control unit 21 included in the distributed station 80g acquires the delay control instruction output from the control determination unit 31. On the basis of the acquired delay control instruction, the delay control unit 21 executes the adjustment processing on a plurality of packets included in the signal of each traffic flow received by the distributed station 80g at a timing later than the signal received by the distributed station 80g in the processing of step S701 (step S704). Thus, the packet intervals of the plurality of packets are uniformly adjusted, and the jitter is reduced. Thereafter, the plurality of packets after the adjustment processing is transferred to the server 10 via the transfer device 20e.

With the signal transfer system 100g configured as described above, the control determination unit 31 included in the distributed station 80g estimates the delay value occurring in the wireless section for each packet on the basis of the wireless control information for each traffic flow acquired by the information acquisition unit 41 of the central station 70g. In particular, the signal transfer system 100g estimates the delay value for performing the adjustment processing of each packet input to the distributed station 80g in the future. Then, the delay control unit 21 included in the distributed station 80g executes the adjustment processing of adjusting the packet interval of a plurality of packets to be input in the future by using the delay value for each packet included in the delay control instruction. This makes it possible to reduce jitter occurring in the uplink.

Furthermore, in the signal transfer system 100g, the base station 40g performs from acquisition of the wireless control information to the adjustment processing. Thus, the transfer device 20e need not include the function of performing the adjustment processing. Therefore, a transfer device having a normal transfer function can be used as the transfer device 20e.

### [Fourth Configuration of Third Embodiment]

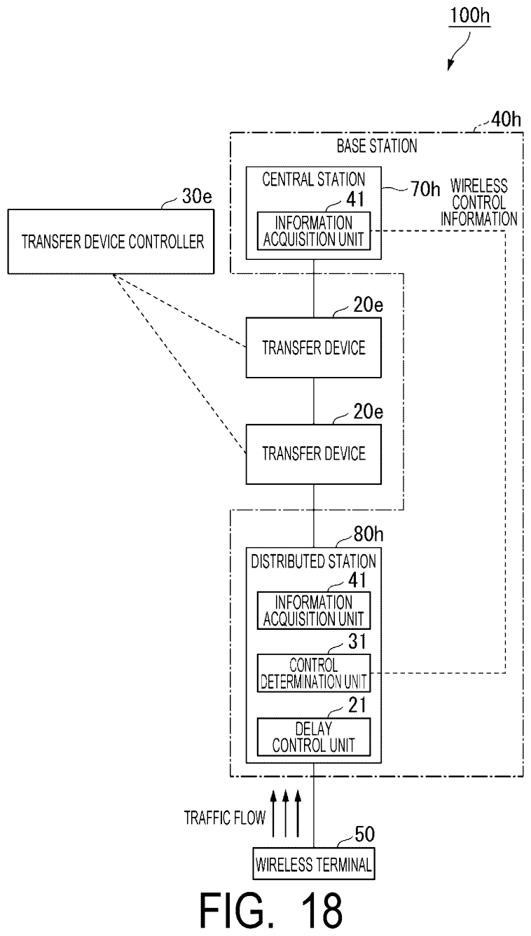

FIG. 18 is a diagram illustrating a system configuration example of a signal transfer system 100h in a fourth configuration of the third embodiment. The signal transfer system 100h includes, for example, one or more transfer devices 20e, the transfer device controller 30e, and a base station 40h. As described above, the signal transfer system 100h is different from the signal transfer system 100e in that it does not include the server 10 but includes the base station 40h including a central station 70h and one or more distributed stations 80h instead of the base station 40e. Hereinafter, differences from the signal transfer system 100e will be mainly described.

The central station 70h and one or more distributed stations 80h are configured using, for example, a processor such as a CPU, a memory, and a communication interface. Each device of the central station 70h and the one or more distributed stations 80h functions as a communication device including a control unit when the processor executes a program.

The control unit provides each function for causing the communication device to function as the central station 70h or the distributed station 80h. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disc, a ROM, a CD-ROM, or a semiconductor storage device (for example, SSD), or a storage device such as a hard disk or a semiconductor storage device built in a computer system. The above program may be transmitted via a telecommunication line.

For example, the central station 70h and one or more distributed stations 80h in the fourth configuration of the third embodiment are a CU and one or more DUs in the mobile communication system. In this case, a section between the CU and the DUs where transfer devices 20e are installed is referred to as MMH. For example, the central station 70h and the one or more distributed stations 80h in the fourth configuration of the third embodiment may be a DU and one or more RUs in the mobile communication system. In this case, a section between the DU and the RUs where transfer devices 20e are installed is referred to as MFH.

Note that the central station 70h may be a Wi-Fi controller, and one or more distributed stations 80h may be Wi-Fi access points. The signal transfer system 100h is not necessarily applied to the mobile communication system, and may be applied to a wireless communication system other than the mobile communication system.

The central station 70h is a central station that transmits and receives signals. Furthermore, the central station 70h includes the information acquisition unit 41. The information acquisition unit 41 included in the central station 70h acquires the wireless control information for each traffic flow from the wireless terminal 50 toward the server 10. The information acquisition unit 41 included in the central station 70h notifies the distributed station 80h of the acquired wireless control information. The central station 70h is an aspect of the upper device.

The distributed station 80h is a device that communicates with the wireless terminal 50. The distributed station 80h transmits a signal transferred from the transfer device 20e to the wireless terminal 50 or transfers a signal received from the wireless terminal 50 to the transfer device 20e of the transfer destination by communication with the wireless terminal 50. The distributed station 80h includes the delay control unit 21, the control determination unit 31, and the information acquisition unit 41. The information acquisition unit 41 included in the base station 40h acquires the wireless control information for each traffic flow from the wireless terminal 50 toward the server 10. The information acquisition unit 41 included in the base station 40h notifies the control determination unit 31 of the acquired wireless control information. The control determination unit 31 included in the base station 40h acquires the wireless control information acquired by the information acquisition unit 41 included in the central station 70h and the wireless control information acquired by the information acquisition unit 41 included in the distributed station 80g. The control determination unit 31 estimates a delay value occurring in the wireless section for each packet in a plurality of traffic flows on the basis of the acquired wireless control information. The control determination unit 31 outputs a delay control instruction for executing the adjustment processing using the estimated delay value for each packet to the delay control unit 21. The delay control unit 21 included in the central station 70h executes the adjustment processing in accordance with the delay control instruction output from the control determination unit 31.

In the signal transfer system 100h in the fourth configuration of the third embodiment, the information acquisition unit 41 is included in the control unit of the central station 70h, and the delay control unit 21, the control determination unit 31, and the information acquisition unit 41 are included in the control unit of the distributed station 80h.

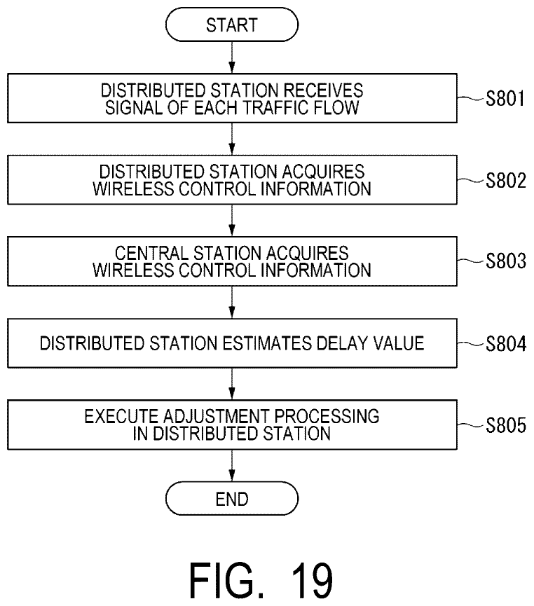

FIG. 19 is a flowchart illustrating an example of a flow of processing executed by the signal transfer system 100h in the fourth configuration of the third embodiment. In the signal transfer system 100h, the processing illustrated in FIG. 19 is repeatedly performed.

The distributed station 80h receives a signal of each traffic flow (step Sz). The information acquisition unit 41 included in the distributed station 80h acquires the wireless control information for each traffic flow on the basis of the received signal (step S802). The information acquisition unit 41 outputs the acquired wireless control information to the control determination unit 31. Furthermore, the distributed station 80h transfers the received signal to the transfer device 20e to which the own device is connected.

The transfer device 20e transfers the signal of each traffic flow transmitted from the distributed station 80h to the central station 70h. The central station 70h receives the signal of each traffic flow transferred from the transfer device 20e. The information acquisition unit 41 included in the central station 70h acquires the wireless control information for each traffic flow on the basis of the received signal (step S803). The information acquisition unit 41 transmits the acquired wireless control information to the distributed station 80h.

The control determination unit 31 included in the distributed station 80h acquires the wireless control information transmitted from each information acquisition unit 41. The control determination unit 31 estimates the delay value for each packet using a plurality of pieces of the acquired wireless control information (step S804). Specifically, the control determination unit 31 included in the distributed station 80h estimates a delay value for each packet used for executing the adjustment processing on each packet included in the signal of each traffic flow received by the distributed station 80h in the processing of step S801 on the basis of the wireless control information acquired by the information acquisition unit 41 of the distributed station 80h.

As illustrated in FIG. 18, in a case where the information acquisition unit 41 is included in the central station 70h, the control determination unit 31 included in the distributed station 80h performs delay control of the packet input to the distributed station 80h at the next timing on the basis of the band information included in the wireless control information acquired from the information acquisition unit 41 included in the central station 70h. For example, the control determination unit 31 estimates the delay value for each packet input to the distributed station 80h at the next timing on the basis of information indicating future information included in the band information. As described above, in the signal transfer system 100h, the control determination unit 31 estimates the delay value for performing the adjustment processing of each packet input to the distributed station 80h at the present and future timings on the basis of the wireless control information acquired by the information acquisition unit 41 of the distributed station 80h and the wireless control information acquired by the information acquisition unit 41 of the central station 70h. Thereafter, the control determination unit 31 generates a delay control instruction including information of the estimated delay value for each packet. The control determination unit 31 outputs the generated delay control instruction to the delay control unit 21.

The delay control unit 21 acquires the delay control instruction output from the control determination unit 31. The delay control unit 21 executes the adjustment processing on a plurality of packets on the basis of the acquired delay control instruction (step S805). For example, the delay control unit 21 executes the adjustment processing on a plurality of packets included in the signal received by the distributed station 80h in the processing of step S801 by using information of the delay value for each packet estimated on the basis of the wireless control information acquired by the information acquisition unit 41 of the distributed station 80h. Furthermore, the delay control unit 21 executes the adjustment processing on a plurality of packets included in the signal of each traffic flow received by the distributed station 80h at a timing later than the signal received by the distributed station 80h in the processing of step S801 by using information of the delay value for each packet estimated on the basis of the wireless control information acquired by the information acquisition unit 41 of the central station 70h. Thus, the packet intervals of the plurality of packets are uniformly adjusted, and the jitter is reduced. Thereafter, the plurality of packets after the adjustment processing is transferred to the server 10.

With the signal transfer system 100h configured as described above, the control determination unit 31 included in the distributed station 80h estimates the delay value occurring in the wireless section for each packet on the basis of the wireless control information for each traffic flow acquired by the central station 70h and the wireless control information for each traffic flow acquired by the distributed station 80h. In particular, the signal transfer system 100h estimates the delay value for performing the adjustment processing on each packet input at present and in the future to the distributed station 80h. Then, the control determination unit 31 gives a delay control instruction for executing the adjustment processing using the estimated delay value for each packet to the delay control unit 21. Thus, the delay control unit 21 included in the distributed station 80h executes the adjustment processing of adjusting the packet interval of a plurality of packets to be input at present and in the future by using the delay value for each packet included in the delay control instruction. This makes it possible to reduce jitter occurring in the uplink.

Furthermore, in the signal transfer system 100h, the base station 40h performs from acquisition of the wireless control information to the adjustment processing. Thus, the transfer device 20e need not include the function of performing the adjustment processing. Therefore, a transfer device having a normal transfer function can be used as the transfer device 20e.

### Fourth Embodiment

In a fourth embodiment, a signal transfer system that performs the adjustment processing in a transfer device and acquires the wireless control information and transmits a delay control instruction in a base station will be described. Note that, in the fourth embodiment, four configuration examples will be described.

### [First Configuration of Fourth Embodiment]

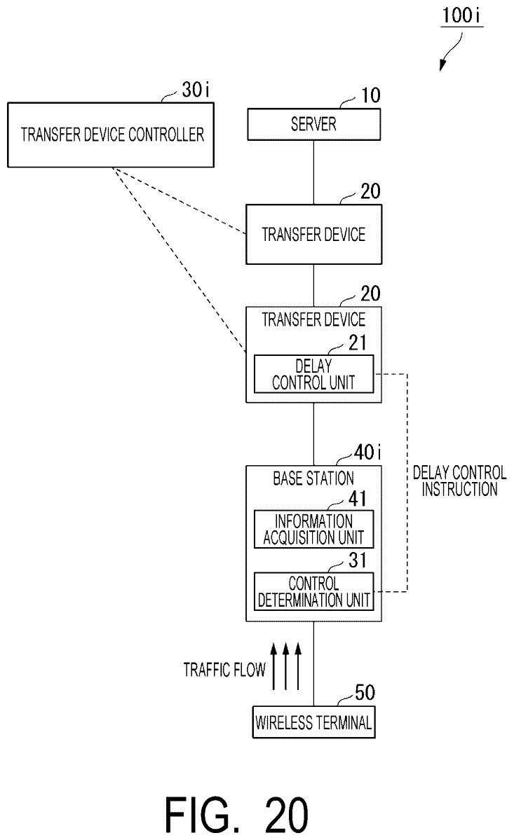

FIG. 20 is a diagram illustrating a system configuration example of a signal transfer system 100i in a first configuration of the fourth embodiment. The signal transfer system 100i includes, for example, one or more transfer devices 20, a transfer device controller 30i, and a base station 40i. As described above, the signal transfer system 100i is different from the signal transfer system 100 in including the transfer device controller 30i and the base station 40i instead of the transfer device controller 30 and the base station 40. Hereinafter, differences from the signal transfer system 100 will be mainly described.

The base station 40i is configured using, for example, a processor such as a CPU, a memory, and a communication interface. The device of the base station 40i functions as a communication device including a control unit when the processor executes a program.

The control unit provides each function for causing the communication device to function as the base station 40i. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disc, a ROM, a CD-ROM, or a semiconductor storage device (for example, SSD), or a storage device such as a hard disk or a semiconductor storage device built in a computer system. The above program may be transmitted via a telecommunication line.

The transfer device controller 30i is different from the transfer device controller 30 in not including the control determination unit 31. That is, the transfer device controller 30i does not estimate the delay value for each packet and does not transmit the delay control instruction. The transfer device controller 30i is a device that controls the one or more transfer devices 20 by transmitting control signals.

The base station 40i includes a control determination unit 31 and an information acquisition unit 41. The information acquisition unit 41 included in the base station 40i acquires the wireless control information for each traffic flow from the wireless terminal 50 toward the server 10. The information acquisition unit 41 included in the base station 40i notifies the control determination unit 31 of the acquired wireless control information. The control determination unit 31 included in the base station 40i acquires the wireless control information acquired by the information acquisition unit 41. The control determination unit 31 estimates a delay value occurring in the wireless section for each packet in a plurality of traffic flows on the basis of the acquired wireless control information. The control determination unit 31 transmits a delay control instruction for executing the adjustment processing using the estimated delay value for each packet to the transfer device 20.

In the signal transfer system 100i in the first configuration of the fourth embodiment, the delay control unit 21 is included in the control unit of the transfer device 20, and the control determination unit 31 and the information acquisition unit 41 are included in the control unit of the base station 40i.

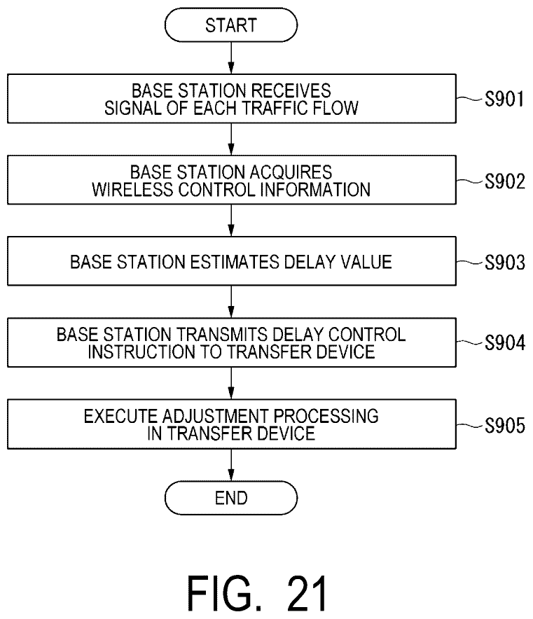

FIG. 21 is a flowchart illustrating an example of a flow of processing executed by the signal transfer system 100i in the first configuration of the fourth embodiment. In the signal transfer system 100i, the processing illustrated in FIG. 21 is repeatedly performed.

The base station 40i receives a signal of each traffic flow (step S901). The information acquisition unit 41 included in the base station 40i acquires the wireless control information for each traffic flow on the basis of the received signal (step S902). The information acquisition unit 41 outputs the acquired wireless control information to the control determination unit 31.

The control determination unit 31 included in the base station 40i acquires the wireless control information output from the information acquisition unit 41. The control determination unit 31 estimates the delay value for each packet using the acquired wireless control information (step S903). Thereafter, the control determination unit 31 generates a delay control instruction including information of the estimated delay value for each packet. The control determination unit 31 transmits the generated delay control instruction to the transfer device 20. Furthermore, the base station 40i transmits the signal of each traffic flow received from the wireless terminal 50 to the transfer device 20 (step S904).

The delay control unit 21 included in the transfer device 20 acquires the delay control instruction transmitted from the base station 40i. The delay control unit 21 executes the adjustment processing on a plurality of packets on the basis of the acquired delay control instruction (step S905). Thus, the packet intervals of the plurality of packets are uniformly adjusted, and the jitter is reduced. Thereafter, the plurality of packets after the adjustment processing is transferred to the server 10 via the transfer device 20.

With the signal transfer system 100i configured as described above, the control determination unit 31 included in the base station 40i estimates the delay value occurring in the wireless section for each packet on the basis of the acquired wireless control information for each traffic flow. Then, the delay control unit 21 included in the transfer device 20 executes the adjustment processing of adjusting the packet interval of the plurality of packets by using the delay value for each packet included in the delay control instruction. This makes it possible to reduce jitter occurring in the uplink.

### [Second Configuration of Fourth Embodiment]

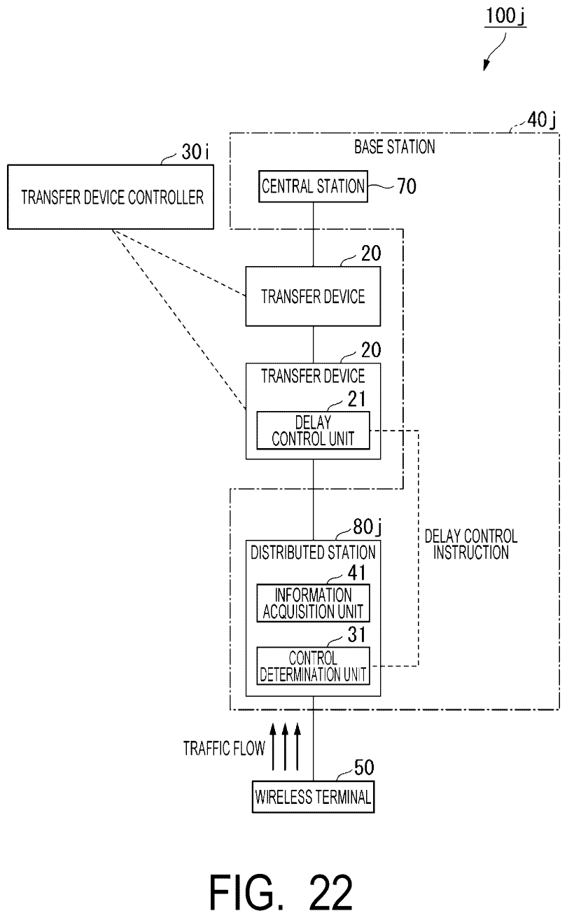

FIG. 22 is a diagram illustrating a system configuration example of a signal transfer system 100j in a second configuration of the fourth embodiment. The signal transfer system 100j includes, for example, one or more transfer devices 20, the transfer device controller 30i, and a base station 40j. As described above, the signal transfer system 100j is different from the signal transfer system 100i in that it does not include the server 10 but includes the base station 40j including the central station 70 and one or more distributed stations 80j instead of the base station 40i. Hereinafter, differences from the signal transfer system 100i will be mainly described.

The distributed station 80j is configured using, for example, a processor such as a CPU, a memory, and a communication interface. The device of the distributed station 80j functions as a communication device including a control unit when the processor executes a program.

The control unit provides each function for causing the communication device to function as the distributed station 80j. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disc, a ROM, a CD-ROM, or a semiconductor storage device (for example, SSD), or a storage device such as a hard disk or a semiconductor storage device built in a computer system. The above program may be transmitted via a telecommunication line.

For example, the central station 70 and one or more distributed stations 80j in the second configuration of the fourth embodiment are a CU and one or more DUs in the mobile communication system. In this case, a section between the CU and the DUs where transfer devices 20 are installed is referred to as MMH. For example, the central station 70 and one or more distributed stations 80j in the second configuration of the fourth embodiment may be a DU and one or more RUs in the mobile communication system. In this case, a section between the DU and the RUs where transfer devices 20 are installed is referred to as MFH.

Note that the central station 70 may be a Wi-Fi controller, and one or more distributed stations 80j may be Wi-Fi access points. The signal transfer system 100j is not necessarily applied to the mobile communication system, and may be applied to a wireless communication system other than the mobile communication system.

The central station 70 is a central station that transmits and receives signals. The central station 70 is an aspect of the upper device.

The distributed station 80j is a device that communicates with the wireless terminal 50. The distributed station 80j transmits a signal transferred from the transfer device 20 to the wireless terminal 50 or transfers a signal received from the wireless terminal 50 to the transfer device 20 of the transfer destination by communication with the wireless terminal 50.

The distributed station 80j includes the control determination unit 31 and the information acquisition unit 41. The information acquisition unit 41 included in the distributed station 80j acquires the wireless control information for each traffic flow from the wireless terminal 50 toward the server 10. The information acquisition unit 41 included in the distributed station 80j notifies the control determination unit 31 of the acquired wireless control information. The control determination unit 31 included in the distributed station 80j acquires the wireless control information acquired by the information acquisition unit 41. The control determination unit 31 estimates a delay value occurring in the wireless section for each packet in a plurality of traffic flows on the basis of the acquired wireless control information. The control determination unit 31 transmits a delay control instruction for executing the adjustment processing using the estimated delay value for each packet to the transfer device 20.

In the signal transfer system 100j in the second configuration of the fourth embodiment, the delay control unit 21 is included in the control unit of the transfer device 20, and the control determination unit 31 and the information acquisition unit 41 are included in the control unit of the distributed station 80j.

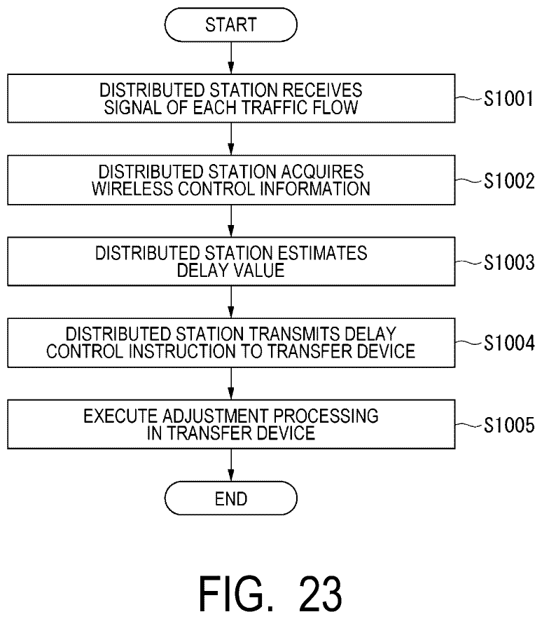

FIG. 23 is a flowchart illustrating an example of a flow of processing executed by the signal transfer system 100j in the second configuration of the fourth embodiment. In the signal transfer system 100j, the processing illustrated in FIG. 23 is repeatedly performed.

The distributed station 80j receives a signal of each traffic flow (step S1001). The information acquisition unit 41 included in the distributed station 80j acquires the wireless control information for each traffic flow on the basis of the received signal (step S1002). The information acquisition unit 41 outputs the acquired wireless control information to the control determination unit 31.

The control determination unit 31 included in the distributed station 80j acquires the wireless control information output from the information acquisition unit 41. The control determination unit 31 estimates the delay value for each packet using the acquired wireless control information (step S1003). Thereafter, the control determination unit 31 generates a delay control instruction including information of the estimated delay value for each packet. The control determination unit 31 transmits the generated delay control instruction to the transfer device 20 (step S1004).

The delay control unit 21 included in the distributed station 80g acquires the delay control instruction transmitted from the distributed station 80j. The delay control unit 21 executes the adjustment processing on a plurality of packets on the basis of the acquired delay control instruction (step S1005). Thus, the packet intervals of the plurality of packets are uniformly adjusted, and the jitter is reduced. Thereafter, the plurality of packets after the adjustment processing is transferred to the server 10 via the transfer device 20.

With the signal transfer system 100j configured as described above, the control determination unit 31 included in the distributed station 80j estimates the delay value occurring in the wireless section for each packet on the basis of the acquired wireless control information for each traffic flow. Then, the delay control unit 21 included in the transfer device 20 executes the adjustment processing of adjusting the packet interval of the plurality of packets by using the delay value for each packet included in the delay control instruction. This makes it possible to reduce jitter occurring in the uplink.

### [Third Configuration of Fourth Embodiment]

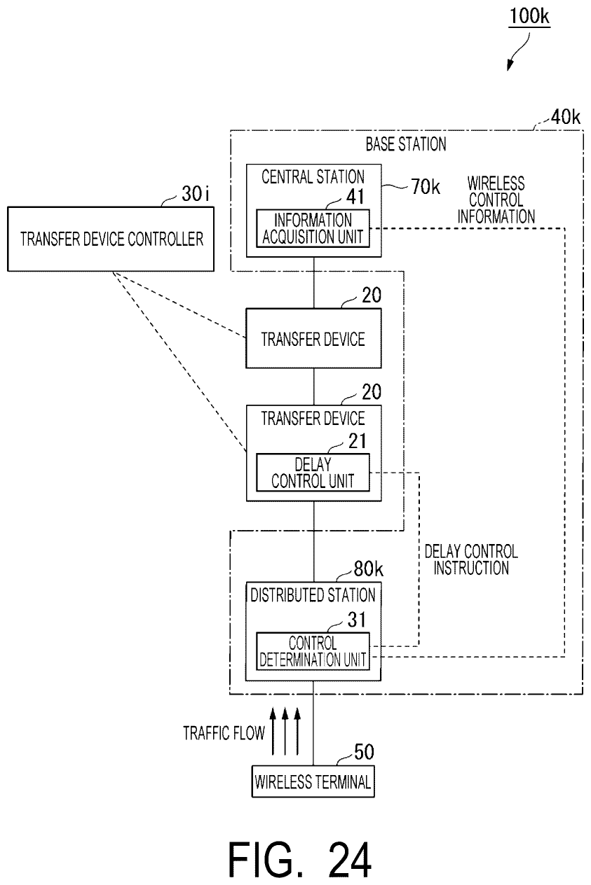

FIG. 24 is a diagram illustrating a system configuration example of a signal transfer system 100k in a third configuration of the fourth embodiment. The signal transfer system 100k includes, for example, one or more transfer devices 20, the transfer device controller 30i, and a base station 40k. As described above, the signal transfer system 100k is different from the signal transfer system 100i in that it does not include the server 10 but includes the base station 40k including the central station 70k and one or more distributed stations 80k instead of the base station 40i. Hereinafter, differences from the signal transfer system 100i will be mainly described.

The central station 70k and the distributed station 80k are configured using, for example, a processor such as a CPU, a memory, and a communication interface. Each device of the central station 70k and the distributed station 80k functions as a communication device including a control unit when the processor executes a program.

The control unit provides each function for causing the communication device to function as the central station 70k or the distributed station 80k. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disc, a ROM, a CD-ROM, or a semiconductor storage device (for example, SSD), or a storage device such as a hard disk or a semiconductor storage device built in a computer system. The above program may be transmitted via a telecommunication line.

For example, the central station 70k or the distributed station 80k in the third configuration of the fourth embodiment is a CU and one or more DUs in the mobile communication system. In this case, a section between the CU and the DUs where transfer devices 20 are installed is referred to as MMH. For example, the central station 70k or the distributed station 80k in the third configuration of the fourth embodiment may be a DU and one or more RUs in the mobile communication system. In this case, a section between the DU and the RUs where transfer devices 20 are installed is referred to as MFH.

Note that the central station 70k may be a Wi-Fi controller, and one or more distributed stations 80k may be Wi-Fi access points. The signal transfer system 100k is not necessarily applied to the mobile communication system, and may be applied to a wireless communication system other than the mobile communication system.

The central station 70k is a central station that transmits and receives signals. Furthermore, the central station 70k includes the information acquisition unit 41. The information acquisition unit 41 included in the central station 70k acquires the wireless control information for each traffic flow from the wireless terminal 50 toward the server 10. The information acquisition unit 41 included in the central station 70k notifies the distributed station 80k of the acquired wireless control information. The central station 70k is an aspect of the upper device.

The distributed station 80k is a device that communicates with the wireless terminal 50. The distributed station 80k transmits a signal transferred from the transfer device 20 to the wireless terminal 50 or transfers a signal received from the wireless terminal 50 to the transfer device 20 of the transfer destination by communication with the wireless terminal 50.

The distributed station 80k includes a control determination unit 31. The control determination unit 31 included in the distributed station 80k acquires the wireless control information acquired by the information acquisition unit 41 of the central station 70k. The control determination unit 31 estimates a delay value occurring in the wireless section for each packet in a plurality of traffic flows on the basis of the acquired wireless control information. The control determination unit 31 transmits a delay control instruction for executing the adjustment processing using the estimated delay value for each packet to the transfer device 20.

In the signal transfer system 100k in the third configuration of the fourth embodiment, the delay control unit 21 is included in the control unit of the transfer device 20, the control determination unit 31 is included in the control unit of the distributed station 80k, and the information acquisition unit 41 is included in the control unit of the central station 70k.

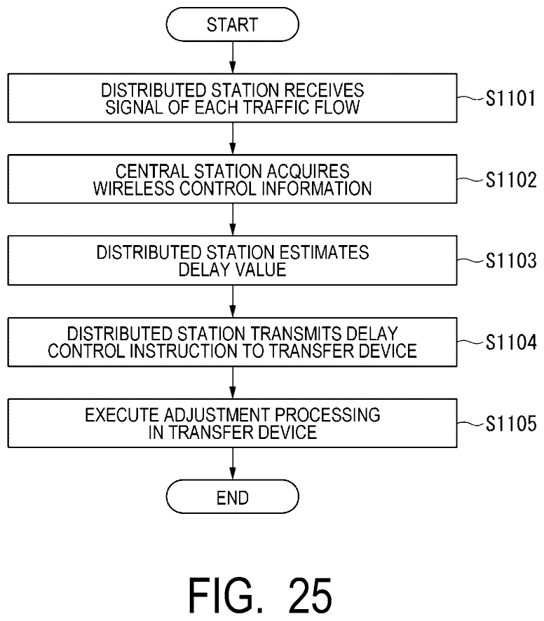

FIG. 25 is a flowchart illustrating an example of a flow of processing executed by the signal transfer system 100k in the third configuration of the fourth embodiment. In the signal transfer system 100k, the processing illustrated in FIG. 25 is repeatedly performed.

The distributed station 80k receives a signal of each traffic flow (step S1101). The distributed station 80k transmits the received signal of each traffic flow to the transfer device 20. The transfer device 20 transfers the signal of each traffic flow transmitted from the distributed station 80k to the central station 70k. The central station 70k receives the signal of each traffic flow transferred from the transfer device 20.

The information acquisition unit 41 included in the central station 70k acquires the wireless control information for each traffic flow on the basis of the received signal (step S1102). The information acquisition unit 41 transmits the acquired wireless control information to the control determination unit 31 included in the distributed station 80k. For example, the information acquisition unit 41 transmits the wireless control information to the control determination unit 31 included in the distributed station 80k via the transfer device 20.

The control determination unit 31 included in the distributed station 80k acquires the wireless control information transmitted from the information acquisition unit 41 included in the central station 70k. The control determination unit 31 estimates the delay value for each packet using the acquired wireless control information (step S1103). As illustrated in FIG. 24, in a case where the information acquisition unit 41 is included in the central station 70k, the control determination unit 31 included in the distributed station 80k performs delay control of the packet input to the transfer device 20 at the next timing on the basis of the band information included in the wireless control information acquired from the information acquisition unit 41. For example, the control determination unit 31 estimates the delay value for each packet input to the transfer device 20 at the next timing on the basis of information indicating future information included in the band information. As described above, in the signal transfer system 100k, the control determination unit 31 estimates the delay value for performing the adjustment processing of each packet input to the transfer device 20 in the future. Thereafter, the control determination unit 31 generates a delay control instruction including information of the estimated delay value for each packet. The control determination unit 31 transmits the generated delay control instruction to the transfer device 20 (step S1104).

The delay control unit 21 included in the transfer device 20 acquires the delay control instruction transmitted from the base station 40k. On the basis of the acquired delay control instruction, the delay control unit 21 executes the adjustment processing on a plurality of packets included in the signal of each traffic flow received by the distributed station 80k at a timing later than the signal received by the distributed station 80k in the processing of step S1101 (step S1105). Thus, the packet intervals of the plurality of packets are uniformly adjusted, and the jitter is reduced. Thereafter, the plurality of packets after the adjustment processing is transferred to the server 10 via the transfer device 20.

With the signal transfer system 100k configured as described above, the control determination unit 31 included in the distributed station 80k estimates the delay value occurring in the wireless section for each packet on the basis of the acquired wireless control information for each traffic flow. In particular, the signal transfer system 100k estimates the delay value for performing the adjustment processing of each packet input to the transfer device 20 in the future. Then, the delay control unit 21 included in the transfer device 20 executes the adjustment processing of adjusting the packet interval of a plurality of packets to be input in the future by using the delay value for each packet included in the delay control instruction. This makes it possible to reduce jitter occurring in the uplink.

### [Fourth Configuration of Fourth Embodiment]

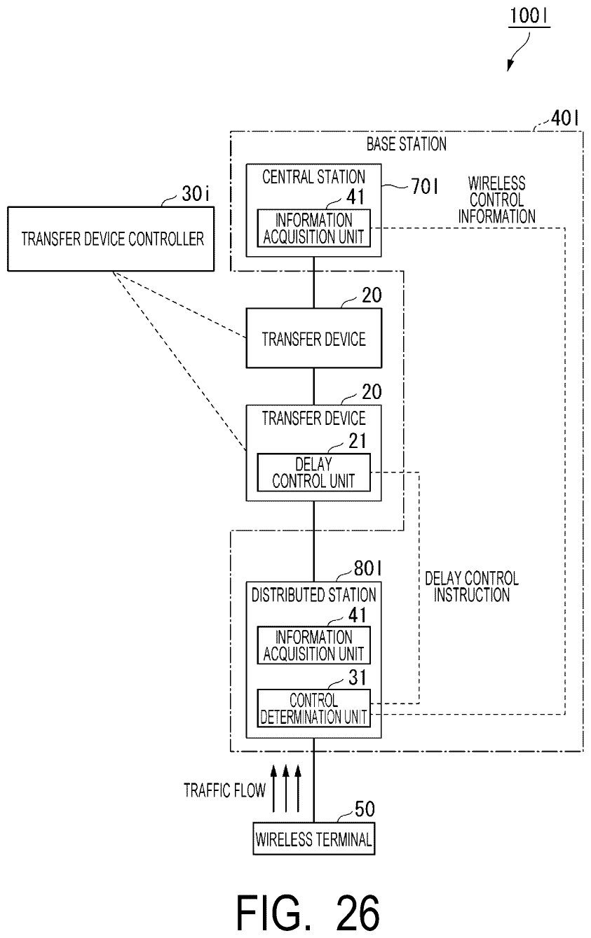

FIG. 26 is a diagram illustrating a system configuration example of a signal transfer system 100l in a fourth configuration of the fourth embodiment. The signal transfer system 100l includes, for example, one or more transfer devices 20, the transfer device controller 30i, and a base station 40l. As described above, the signal transfer system 100l is different from the signal transfer system 100e in that it does not include the server 10 but includes the base station 40l including a central station 70l and one or more distributed stations 80l instead of the base station 40e. Hereinafter, differences from the signal transfer system 100e will be mainly described.

The central station 70l and one or more distributed stations 80l are configured using, for example, a processor such as a CPU, a memory, and a communication interface. Each device of the central station 70l and the one or more distributed stations 80l functions as a communication device including a control unit when the processor executes a program.

The control unit provides each function for causing the communication device to function as the central station 70l or the distributed station 80l. Note that all or some of the functions of the control unit may be implemented by using hardware such as an ASIC, a PLD, or an FPGA. The program may be recorded on a computer-readable recording medium. The computer-readable recording medium is, for example, a portable medium such as a flexible disk, a magneto-optical disc, a ROM, a CD-ROM, or a semiconductor storage device (for example, SSD), or a storage device such as a hard disk or a semiconductor storage device built in a computer system. The above program may be transmitted via a telecommunication line.

For example, the central station 70l and one or more distributed stations 80l in the fourth configuration of the fourth embodiment are a CU and one or more DUs in the mobile communication system. In this case, a section between the CU and the DUs where transfer devices 20 are installed is referred to as MMH. For example, the central station 70l and the one or more distributed stations 80l in the fourth configuration of the fourth embodiment may be a DU and one or more RUs in the mobile communication system. In this case, a section between the DU and the RUs where transfer devices 20 are installed is referred to as MFH.

Note that the central station 70l may be a Wi-Fi controller, and one or more distributed stations 80l may be Wi-Fi access points. The signal transfer system 100l is not necessarily applied to the mobile communication system, and may be applied to a wireless communication system other than the mobile communication system.

The central station 70l is a central station that transmits and receives signals. Furthermore, the central station 70l includes the information acquisition unit 41. The information acquisition unit 41 included in the central station 70l acquires the wireless control information for each traffic flow from the wireless terminal 50 toward the server 10. The information acquisition unit 41 included in the central station 70l notifies the distributed station 80l of the acquired wireless control information. The central station 70l is an aspect of the upper device.

The distributed station 80l is a device that communicates with the wireless terminal 50. The distributed station 80l transmits a signal transferred from the transfer device 20 to the wireless terminal 50 or transfers a signal received from the wireless terminal 50 to the transfer device 20 of the transfer destination by communication with the wireless terminal 50. The distributed station 80l includes the control determination unit 31 and the information acquisition unit 41. The information acquisition unit 41 included in the base station 40l acquires the wireless control information for each traffic flow from the wireless terminal 50 toward the server 10. The information acquisition unit 41 included in the base station 40l notifies the control determination unit 31 of the acquired wireless control information. The control determination unit 31 included in the base station 40l acquires the wireless control information acquired by the information acquisition unit 41 included in the central station 70l and the wireless control information acquired by the information acquisition unit 41 included in the distributed station 80l. The control determination unit 31 estimates a delay value occurring in the wireless section for each packet in a plurality of traffic flows on the basis of the acquired wireless control information. The control determination unit 31 transmits a delay control instruction for executing the adjustment processing using the estimated delay value for each packet to the transfer device 20. The delay control unit 21 included in the transfer device 20 executes the adjustment processing in accordance with the delay control instruction transmitted from the base station 40l.

In the signal transfer system 100l in the fourth configuration of the fourth embodiment, the delay control unit 21 is included in the control of the transfer device 20, the information acquisition unit 41 is included in the control unit of the central station 70l, and the control determination unit 31 and the information acquisition unit 41 are included in the control unit of the distributed station 80l.

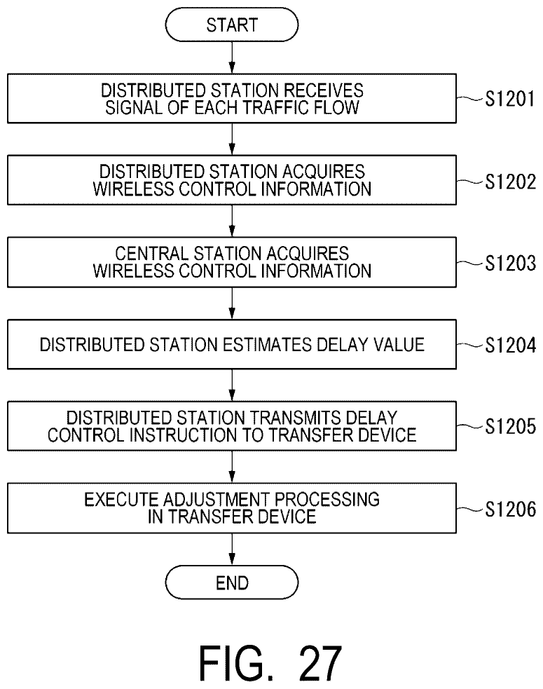

FIG. 27 is a flowchart illustrating an example of a flow of processing executed by the signal transfer system 100l in the fourth configuration of the fourth embodiment. In the signal transfer system 100l, the processing illustrated in FIG. 27 is repeatedly performed.

The distributed station 80l receives a signal of each traffic flow (step S1201). The information acquisition unit 41 included in the distributed station 80l acquires the wireless control information for each traffic flow on the basis of the received signal (step S1202). The information acquisition unit 41 outputs the acquired wireless control information to the control determination unit 31. Furthermore, the distributed station 80l transfers the received signal to the transfer device 20 to which the own device is connected.

The transfer device 20 transfers the signal of each traffic flow transmitted from the distributed station 80l to the central station 70l. The central station 70l receives the signal of each traffic flow transferred from the transfer device 20. The information acquisition unit 41 included in the central station 70l acquires the wireless control information for each traffic flow on the basis of the received signal (step S1203). The information acquisition unit 41 transmits the acquired wireless control information to the distributed station 80l.

The control determination unit 31 included in the distributed station 80l acquires the wireless control information transmitted from each information acquisition unit 41. The control determination unit 31 estimates the delay value for each packet using a plurality of pieces of the acquired wireless control information (step S1204). Specifically, the control determination unit 31 included in the distributed station 80l estimates a delay value for each packet used for executing the adjustment processing on each packet included in the signal of each traffic flow received by the distributed station 80l in the processing of step S1201 on the basis of the wireless control information acquired by the information acquisition unit 41 of the distributed station 80l.

As illustrated in FIG. 26, in a case where the information acquisition unit 41 is included in the central station 70l, the control determination unit 31 included in the distributed station 80l performs delay control of the packet input to the transfer device 20 at the next timing on the basis of the band information included in the wireless control information acquired from the information acquisition unit 41 included in the central station 70l. For example, the control determination unit 31 estimates the delay value for each packet input to the transfer device 20 at the next timing on the basis of information indicating future information included in the band information. As described above, in the signal transfer system 100l, the control determination unit 31 estimates the delay value for performing the adjustment processing of each packet input to the transfer device 20 at the present and future timings on the basis of the wireless control information acquired by the information acquisition unit 41 of the distributed station 80l and the wireless control information acquired by the information acquisition unit 41 of the central station 70l. Thereafter, the control determination unit 31 generates a delay control instruction including information of the estimated delay value for each packet. The control determination unit 31 transmits the generated delay control instruction to the transfer device 20 (step S1205).

The delay control unit 21 of the transfer device 20 acquires the delay control instruction output from the control determination unit 31. The delay control unit 21 executes the adjustment processing on a plurality of packets on the basis of the acquired delay control instruction (step S1206). For example, the delay control unit 21 executes the adjustment processing on a plurality of packets included in the signal received by the distributed station 80l in the processing of step S1201 by using information of the delay value for each packet estimated on the basis of the wireless control information acquired by the information acquisition unit 41 of the distributed station 80l. Furthermore, the delay control unit 21 executes the adjustment processing on a plurality of packets included in the signal of each traffic flow received by the distributed station 80l at a timing later than the signal received by the distributed station 80l in the processing of step S1201 by using information of the delay value for each packet estimated on the basis of the wireless control information acquired by the information acquisition unit 41 of the central station 70l. Thus, the packet intervals of the plurality of packets are uniformly adjusted, and the jitter is reduced. Thereafter, the plurality of packets after the adjustment processing is transferred to the server 10.

With the signal transfer system 100l configured as described above, the control determination unit 31 included in the distributed station 80l estimates the delay value occurring in the wireless section for each packet on the basis of the wireless control information for each traffic flow acquired by the central station 70l and the wireless control information for each traffic flow acquired by the distributed station 80l. In particular, the signal transfer system 100l estimates the delay value for performing the adjustment processing of each packet input at present and in the future to the transfer device 20. Then, the control determination unit 31 transmits a delay control instruction for executing the adjustment processing using the estimated delay value for each packet to the transfer device 20. Thus, the delay control unit 21 included in the transfer device 20 executes the adjustment processing of adjusting the packet interval of a plurality of packets to be input at present and in the future by using the delay value for each packet included in the delay control instruction. This makes it possible to reduce jitter occurring in the uplink.

Although the embodiments of the present invention have been described in detail with reference to the drawings, specific configurations are not limited to the embodiments and include design and the like within the gist of the present invention.

### INDUSTRIAL APPLICABILITY

The present invention can be applied to a communication system and a communication control method that accommodate a wireless terminal.

### REFERENCE SIGNS LIST

10 Server
20, 20d, 20 e Transfer device
21 Delay control unit
30, 30d, 30e, 30i Transfer device controller
31 Control determination unit
40, 40b, 40d, 40e, 40f, 40g, 40h, 40i, 40j, 40k Base station
41 Information acquisition unit
50 Wireless terminal
60 Wireless controller
61 Information transfer unit
70, 70c, 70d, 70g, 70h, 70k Central station
80, 80c, 80f, 80g, 80h, 80j, 80k Distributed station
100, 100a, 100b, 100c, 100d, 100e, 100f, 100g, 100h, 100i, 100j, 100k, 100l Signal transfer system

1. A control device that is a transfer device controller in a signal transfer system including one or more base stations that accommodate one or more wireless terminals, one or more transfer devices that transfer uplink communication of the one or more wireless terminals received via the one or more base stations to an upper side, and a transfer device controller that controls the one or more transfer devices, the transfer device controller comprising:
a control determiner configured to acquire wireless control information related to wireless communication between the one or more base stations and the one or more wireless terminals for each of traffic flows from the one or more wireless terminals to an upper device, estimates a delay value occurring in a wireless section for each of packets on a basis of the acquired wireless control information for each of the traffic flows, and performs a delay control instruction for executing adjustment processing of adjusting a packet interval of a plurality of packets by adding a delay to each of the packets using the estimated delay value for each of the packets.

2. The control device according to claim 1, wherein
the wireless control information includes at least information indicating priority of a traffic flow, and
the control determiner performs a delay control instruction for causing the adjustment processing to be executed so as to minimize jitter within a range satisfying a delay requirement while considering priority of each of the traffic flows.

3. The control device according to claim 1, wherein
the control determiner predicts a delay value on a basis of past wireless control information by using machine learning.

4. The control device according to claim 1, wherein
the wireless control information further includes band information of a traffic flow, and information of a time division duplex (TDD) pattern indicating a transmission/reception timing of a packet, a wireless frequency, and a wireless bandwidth.

5. A signal transfer system comprising:
one or more base stations configured to accommodate one or more wireless terminals;
one or more transfer devices configured to transfer uplink communication of the one or more wireless terminals received via the one or more base stations to an upper side;
a transfer device controller configured to controls the one or more transfer devices;
an information acquirer configured to acquire wireless control information related to wireless communication between the one or more base stations and the one or more wireless terminals for each of traffic flows from the one or more wireless terminals to an upper device;
a control determiner configured to estimate a delay value occurring in a wireless section for each of packets on a basis of the wireless control information acquired for each of the traffic flows, and performs a delay control instruction for executing adjustment processing of adjusting a packet interval of a plurality of packets by adding a delay to each of the packets using the estimated delay value for each of the packets; and
a delay controller configured to execute the adjustment processing in accordance with the delay control instruction of the control determiner.

6. The signal transfer system according to claim 5, wherein
the delay controller adds a delay to each of the plurality of packets within a range satisfying a delay requirement.

7. A control method performed by a transfer device controller in a signal transfer system including one or more base stations that accommodate one or more wireless terminals, one or more transfer devices that transfer uplink communication of the one or more wireless terminals received via the one or more base stations to an upper side, and a transfer device controller that controls the one or more transfer devices, the control method comprising:
acquiring wireless control information related to wireless communication between the one or more base stations and the one or more wireless terminals for each of traffic flows from the one or more wireless terminals to an upper device;
estimating a delay value occurring in a wireless section for each of packets on a basis of the acquired wireless control information for each of the traffic flows; and
performing a delay control instruction for executing adjustment processing of adjusting a packet interval of a plurality of packets by adding a delay to each of the packets using the estimated delay value for each of the packets.
